(19) United States
(12) Patent Application Publication
(10) Pub. No.: US 2010/0110932 A1
(43) Pub. Date: May 6, 2010

(54) NETWORK OPTIMISATION SYSTEMS

(75) Inventors: Christopher John Leslie Doran, Cambridge (GB); Stace Hipperson, Chiswick (GB)

Correspondence Address: SNELL & WILMER L.L.P. (Main), 400 EAST VAN BUREN, ONE ARIZONA CENTER, PHOENIX, AZ, 85004-2202, US

(73) Assignee: INTERGENCE OPTIMISATION LIMITED, Cambridgeshire (GB)

(21) Appl. No.: 12/573,287

(22) Filed: Oct. 5, 2009

Related U.S. Application Data
(60) Provisional application No. 61/110,128, filed on Oct. 31, 2008.

(30) Foreign Application Priority Data
Oct. 31, 2008 (GB) 0819985.3

(51) Int. Cl. H04L 12/28

(52) U.S. Cl. 370/254

(57) ABSTRACT

We describe a 3D computer network optimisation tool using network management data including one or more of: network device data including hardware identification data, interface data characterising one or more interfaces of a said network device, firmware identification data for a said network device, operating system identification data for a said network device; information flow data relating to information flow within the network including network device information flow load data and link bandwidth data/statistical information flow data; as well as environmental data for a network device such as temperature or power consumption data and/or physical network device location data. The tool also uses captured network data and sniffer data from communication links; and connectivity of the network devices. A three-dimensional (3D) visualisation module constructs a 3D representation of said network including 3D representations of said network devices in conjunction with a representation of said connectivity in three dimensions.

### CROSS-REFERENCE TO RELATED APPLICATIONS

This application claims priority to U.S. Provisional Application No. 61/110,128 entitled “NETWORK OPTIMISATION SYSTEMS” which was filed on Oct. 31, 2008, and also claims priority to Great Britain Application No. GB0819985.3 entitled “NETWORK OPTIMISATION SYSTEMS” also filed on Oct. 31, 2008, both of which are incorporated herein by reference.

### FIELD OF THE INVENTION

This invention relates to apparatus, methods and computer program code for optimising, mapping, monitoring, visualising, and/or managing computer networks, in embodiments including automatically recording changes to a network.

### BACKGROUND TO THE INVENTION

Businesses increasingly rely upon effective IT infrastructure and applications. Profitability and competitiveness demand IT services are secure, fast and continually available. Businesses that can not guarantee effective IT service delivery are quickly exposed to their shareholders and competitors.

The investments required to prime and manage such services can be significant. Businesses should preferably look to find new processes and systems to increase their competitiveness and reduce costs.

As businesses rely increasingly on their network infrastructure to carry all types of critical applications, voice video and data, their planning and operation has become increasingly complex

Traditionally networks have been represented statically using two dimensions. Network administrators use software to draw logical and physical diagrams representing the network. Networks are also represented using Network Management Systems (NMS), the software automatically draws a diagram or an administrator manually creates a representation. Typically NMS diagrams use colours, flashing icons or similar to alert the operator of any issues.

This approach is acceptable for small and simple networks, but larger organisations with multiple users, locations and critical applications require very complex planning, change management and operational procedures. Attempting to visualise this is extremely difficult. Moreover, when problems appear the complexity can very often lead to the wrong behaviour being applied, which in turn inadvertently exacerbates the problem.

Glendan Clarke and Mckenna (Human Safety and Risk Management, refer to rules being created in hierarchies to enable methodological problem solving. When operators are placed under pressure, these rules are then sometimes broken in an attempt to “gamble with a solution” There are many studies particularly with airline pilots and “operator stress” and information overload where wrong decisions are taken. User intervention on a gamble then makes the situation worse or can lead to catastrophic chain of events.

Many network operators also experience this feeling of panic and helplessness as network alarms sound during a problem and there are huge pressures to restore business connectivity

Currently all network diagrams are represented in 2D so problem solving and planning is difficult to perceive. The ability to be able to delineate different network layers and “walk around the network” in real time should preferably allow network planners and operators to focus on issues and problems in a much more structured and planned approach. This in turn should preferably improve network stability and allow managers to save costs more effectively.

Referring to FIGS. 1 to 3, IT focus has been moving towards capacity management and application performance as the network has become the core of business and commerce in general. The realisation that it doesn't matter what underlying network is available if applications are not performing well has led to many vendors releasing applications and/or hardware to report on application flow and response times. The raw data is captured using either direct sniffing of the network and statistical interpretation or utilising technology similar to Cisco System's Netflow to gather raw network flow data. This data is presented to users via charts (e.g. FIG. 3), spreadsheets, graphs and as network maps (e.g. FIGS. 1 and 2).

Users and administrators can feel overwhelmed by the sheer amount of data that requires interpretation and analysis sometimes under very tight deadlines. It can be difficult to pinpoint specific problems in the network because the user may have to wade through screens of data before getting to the relevant information. Navigating around large networks (eg 100+ or 100+ devices) can be very difficult using conventional approaches.

### SUMMARY OF THE INVENTION

According to one aspect of the invention, there is provided a 3D network optimisation tool for a network comprising a plurality of network devices and communication links between network devices, the tool comprising:

a data integration server to receive network topological data from a database defining said plurality of network devices and communication links, information flow data relating to information flow within said network and connectivity data defining connectivity of said network devices;

a data visualisation client which receives data from said data integration server, said received data being used to define a 3D representation of said network which includes 3D representations of said network devices in conjunction with a representation of said connectivity in three dimensions, said data visualisation client comprising a user interface to display said 3D representation allowing optimisation of said network based on said displayed 3D representation.

The 3D representation of said network preferably uses 3D techniques to visualise networks, network device status/information and application flows in one, easy to understand visualisation. This benefits the user by allowing ease of interpretation and information gathering via a simple navigational interface. Information is intelligently displayed in a granular fashion employing information hiding techniques which ensure the user is not overwhelmed and can instead drill down to identify specific problem areas. This may allow a user to optimise the network or alternatively, there may be an optimisation module which automatically optimises the network based on the representation created.

The tool may further comprise a filter module connected to the data integration server whereby the data integration server processes the received data according to rules and filters defined in said filter module to determine what data is to be displayed and how said data is to be displayed. Said filter module may also be connected to said user interface whereby a user is able to define said rules and filters, for example to pin point areas of the network to be optimised.

The tool may further comprise a translation layer connecting said data integration server and said data visualisation client; said translation layer being operable to process data received from said data integration server to define said 3D representation of said network. The translation layer may also be connected to said user interface whereby a user is able to specify the data to be displayed. A message queue may also be used in the connection between said data integration server and said data visualisation client to manage the large flow of data between the two systems.

The data visualisation client may comprise a 3D renderer connected to said user interface to display on said user interface said 3D representation of said network. Said 3D representation of a said network device may comprise a plurality of 2D panels each corresponding to a face of said 3D representation of said device and comprising information on said network device, wherein said user interface is operable to allow a user to select a said 3D representation and expand a said 3D representation to view any of said 2D panels. In this way, other types of information, including conventional reporting information may be displayed alongside the 3D representation.

Said 3D representation of each said network device may be assigned a colour to represent its temperature and/or its usage. In this way, high/low temperature or under or over utilisation may be flagged easily to a user to enable optimisation. Said data visualisation client may be configured to replay an optimisation of captured data from said network in faster than real time. Such replay may include the various colour depictions. Said data visualisation client may also be configured to depict a communication path of an application operating over said network whereby the 3D computer network optimisation tool is usable for optimisation of network routing

Said user interface may comprise a multi-touch user interface for manipulating said 3D representation of said network, said multi-touch user interface enabling a user of a touch screen displaying said 3D representation, by simultaneously touching said touch screen in two or more different places, to perform one or more of translation, scaling and rotation of said 3D representation of said network to optimise the performance of the network.

The term network encompasses many forms of networks, including computer networks comprising routers, servers, etc. The network may also be a data centre network. The optimisation of the data centre network may to related to any or all of the following lowering energy costs, resolving energy-related issues (which may create outages), deploying industry standards and best industry practice and providing options for power savings associated with future expansion. The network may be also be an information network and optimisation may be of information security. The optimisation may balance security against productivity and/or may optimise virtual environments.

Any of the features of the invention above may be combined with any of the features of the other aspects detailed below.

According to another aspect of the present invention, there is provided a 3D computer network optimisation tool for a computer network comprising a plurality of network devices and communication links between network devices, the tool comprising: an input to receive network management data from a database, said network management data including one or more of: network device data including hardware identification data for hardware network devices of said network and/or interface data characterising one or more interfaces of a said network device and/or firmware identification data for a said network device and/or operating system identification data for a said network device; information flow data relating to information flow within said network said information data including network device information flow load data and/or link bandwidth data and/or statistical information flow data; environmental data relating to a said network device including temperature data and/or electrical power or energy consumption data and/or physical network device location data; captured network data and/or sniffer data from one or more communication links of said network; and connectivity data defining connectivity of said network devices; a three-dimensional (3D) visualisation module to construct a 3D representation of said network; and an output to output data defining said 3D representation of said network, wherein said 3D representation includes 3D representations of said network devices in conjunction with a representation of said connectivity in three dimensions whereby optimisation of said network is based on said 3D representation.

According to another aspect of the present invention, there is provided a method of optimising a computer network comprising a plurality of network devices and communication links between network devices, the method comprising: receiving network management data from a database, said network management data including one or more of: network device data including hardware identification data for hardware network devices of said network and/or interface data characterising one or more interfaces of a said network device and/or firmware identification data for a said network device and/or operating system identification data for a said network device; receiving information flow data relating to information flow within said network said information data including network device information flow load data and/or link bandwidth data and/or statistical information flow data; receiving environmental data relating to a said network device including temperature data and/or electrical power or energy consumption data and/or physical network device location data; receiving communication data from one or more communication links of said network; receiving connectivity data defining connectivity of said network devices; constructing, using said received data, a 3D representation of said network, wherein said 3D representation includes 3D representations of said network devices in conjunction with a representation of said connectivity in three dimensions; and optimising said network using said 3D representation of said network.

According to another aspect of the present invention there is provided a 3D computer network visualisation tool, the tool comprising: an input to receive network management data from a database, said network management data including one or more of: network device data including hardware identification data for hardware network devices of said network and/or interface data characterising one or more interfaces of a said network device and/or firmware identification data for a said network device and/or operating system identification data for a said network device; information flow data relating to information flow within said network said information data including network device information flow load data and/or link bandwidth data and/or statistical information flow data; environmental data relating to a said network device including temperature data and/or electrical power or energy consumption data and/or physical network device location data; captured network data and/or sniffer data from one or more communication links of said network; and connectivity data defining connectivity of said network devices; a three-dimensional (3D) visualisation module to construct a 3D representation of said network; and an output to output data defining said 3D representation of said network, wherein said 3D representation includes 3D representations of said network devices in conjunction with a representation of said connectivity in three dimensions.

In each of the aspects above, the 3D representation may be constructed automatically using a set of rules operating on 3D mapping parameter data associated with one of said plurality of network devices. Said 3D mapping parameter data may comprise one or more of: physical location data for said network device, bandwidth data defining connectivity bandwidth to said network device and network device hierarchy data, said hierarchy data defining said device to be in one of a core region of said network a data distribution portion of said network and a data access or terminal portion of said network. Said network may comprise at least 100 or at least 1000 said network devices and thus large volumes of data about the network may need to be processed.

Said 3D visualisation module may be configured to use a computer graphics hardware acceleration engine. Said 3D visualisation module may be configured to, on selection of said 3D representation of said device, expand a said 3D representation of a said network device into a plurality of 2D panels each corresponding to a face or plane of said 3D representation of said device. Each said panel may represent a different class of information or different graphical representation of information relating to said network device. Said 3D visualisation module may be configured to depict service level agreement (SLA) data, said SLA data comprising one or more of: network device up-time guarantee data; network device response time data; and reliability data or packet acknowledgement response time data derived from packet transmission control protocol or TCP/IP data from said network. Such SLA data may be displayed on any of the panels.

Said input may receive RFID location data for a said network device, and said 3D visualisation module may be configured to depict a physical location of a said network device using said RFID location data.

Said 3D visualisation module may be configured to depict physical connectivity data and a physical connectivity of physical interfaces of said network devices within said network. Said 3D visualisation module may be configured to represent a temperature or other physical characteristic of a said network device by changing a colour of the network device in said 3D representation. Said 3D visualisation module may be configured to replay a visualisation of captured data from said network in faster than real time.

Said 3D visualisation module may be configured to depict logically partitioned sub-regions of said network, a said sub-region comprising a logical partition employed by a packet routing protocol of said network. Said packet routing protocol comprises one or more of OSPF (Open Shortest Path First), RIP, ISIS, EIGRP, and BGP. Said 3D visualisation module may be configured to depict a communication path of an application operating over said network. Said communication path is determined from one or more of: monitoring of actual packet flow within said network, simulation of transmission of a packet within said network, and router configuration tables.

Said 3D visualisation module may be configured to depict virtual machines within said network, wherein a plurality of said virtual machines are associated with a single said network device or server in said network.

Said tool may comprise a multi-touch user interface for manipulating said 3D representation of said network, said multi-touch user interface enabling a user of a touch screen displaying said 3D representation, by simultaneously touching said touch screen in two or more different places, to perform one or more of translation, scaling and rotation of said 3D representation of said network. Said tool may comprise a database coupled to said input, and at least one network appliance coupled to said network to capture said network management data and to store said network management data in said database.

Some particularly useful features which may apply to any/all of the aspects described above are as follows:

Multi faceted device showing device information: When a 3D device is selected it opens up into a multi faceted display with all relevant information being shown on the different facets, including a CLI interface for configuration and command input.

3D SLA view: This shows where in the path the SLA (a set of requirements defined in a Service Level Agreement) has not been met.

Asset management using 3D maps and location sensing RFID: This uses two technologies, 3D visualisation and RFID for asset management and location in data centres.

3D replay: This shows the flow and changes that happened over the course of a defined period in fast motion for capacity planning and troubleshooting visualisation.

Routing protocol 3D views: This shows defined areas and schemas for troubleshooting and design visualisation.

3D application path views: This shows the path an application takes over the network for capacity and routing optimisation views.

3D virtual server view: This shows virtual servers as honeycomb shapes on a server visualisation for monitoring and visualisation of virtual servers.

Multi Touch screen for troubleshooting and capacity management: Using multi-touch screen technology the 3D map is able to be manipulated in a way that enhances troubleshooting, capacity management and network design.

The invention further provides computer program code to implement a system and/or method as described above. The code may be provided on a carrier such as a disk, for example a CD- or DVD-ROM, or in programmed memory for example as Firmware. Code (and/or data) to implement embodiments of the invention may comprise source, object or executable code in a conventional programming language (interpreted or compiled) such as C. As the skilled person should preferably appreciate such code and/or data may be distributed between a plurality of coupled components in communication with one another. The invention still further provides a computer system including the above described tool.

### BRIEF DESCRIPTION OF THE DRAWINGS

These and other aspects of the invention should preferably now be further described, by way of example only with reference to the accompanying figures in which:

FIG. 1 shows a network diagram drawn with Microsoft Visio® according to the prior art;

FIG. 2 shows a typical NMS map (i.e. a traditional 2D network map with static device representation) according to the prior art;

FIG. 3 illustrates application flow data in chart form;

FIG. 4 shows a schematic block diagram of a software suite overview according to an embodiment of an aspect of the invention;

FIG. 5 shows a 3D representation of network data according to an embodiment of the invention;

FIG. 6 shows a 3D network diagram according to an embodiment of the invention;

FIG. 7 shows a 3D network diagram according to an embodiment of the invention illustrating a CPU over threshold;

FIG. 8 shows a 3D network diagram according to an embodiment of the invention illustrating a link threshold;

FIG. 9 shows 3D network diagram according to an embodiment of the invention illustrating a combination view;

FIG. 10 shows 3D octagonal device in a network diagram according to an embodiment of the invention;

FIG. 11 shows a cut-down octagon multi-plane view according to an embodiment of the invention;

FIG. 12 shows a cube device in a network diagram according to an embodiment of the invention;

FIG. 13 shows a cut-down cube multi-plane view according to an embodiment of the invention;

FIG. 14 shows a visualisation of bandwidth link usage according to an embodiment of the invention;

FIG. 15 shows a 3D network diagram according to an embodiment of the invention illustrating SLA measurement between links;

FIG. 16 shows a 3D network diagram according to an embodiment of the invention illustrating a routing protocol configuration;

FIG. 17 shows a 3D network diagram according to an embodiment of the invention illustrating an application traffic path;

FIG. 18 shows a 3D network diagram according to an embodiment of the invention illustrating a sub-optimal network path;

FIG. 19 shows a 3D network diagram according to an embodiment of the invention illustrating power usage, showing three states: green—compliant, blue—under utilised, fire—over utilised;

FIG. 20 shows a hexagonal honeycomb shaped representation of a virtual server virtual machine;

FIG. 21 shows a representation of six virtual servers, one with an alert;

FIG. 22 shows a 3D network diagram with a multi-touch interface according to an embodiment of the invention;

FIGS. 23a and 23b shows example reports by Crystal Reports™ and Jasperforge® respectively;

FIGS. 24 and 25 show examples of graphs and information available from embodiments of the system;

FIG. 26 shows an example software architecture for the system;

FIGS. 27 and 28 shows maps of 3D networks created using two alternative clustering algorithms;

FIG. 29 shows an information ‘halo’ around a node on the network; and

FIG. 30 shows an example architecture for the system.

### DETAILED DESCRIPTION OF PREFERRED EMBODIMENTS

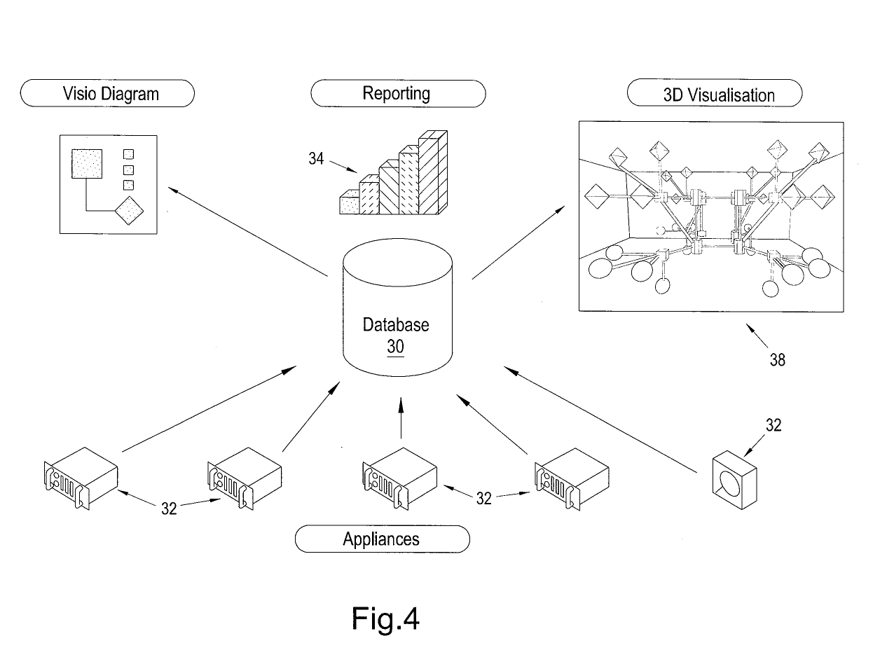

Referring to FIG. 4, broadly speaking we should preferably describe technologies and methods to gain detailed network knowledge and visualise the network in real time to give the network manager and support personnel an excellent understanding of current and future conditions. The system (Intergence Software Suite, ISS) does this by interrogating the network, storing the data in a central repository and then mining this data to enable reports, 2D visualisation and 3D visualisation. ISS has 5 potentially separate modules: Central database 30, Appliances 32, Reporting engine 34, Automatic Microsoft Visio diagram creator 36 and 3D visualisation 38.

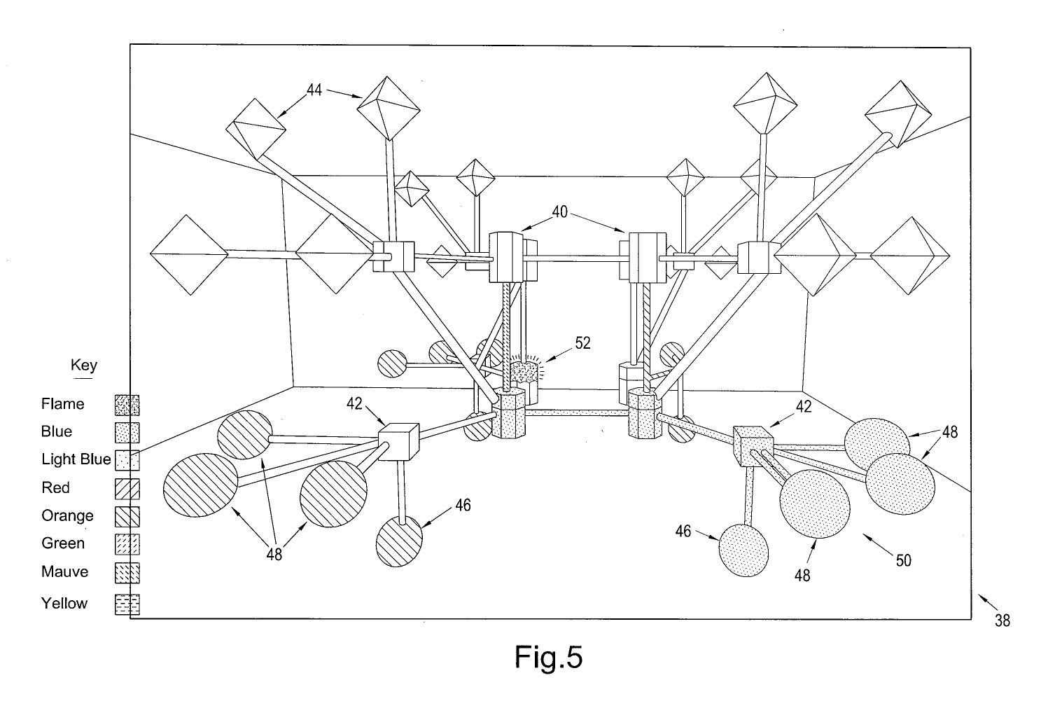

FIG. 5 provides an insight as to how the 3D representation of a network would work with different 3D objects representing different devices present in the network such as firewalls, routers and switches. Animation and coloured textures are applied to the objects to show the current status of that particular device. For example, a device running too hot 52 (e.g. a router) could have a flame texture applied to it and devices with low usage 50 could be coloured blue. With the status being displayed in real time this provides the user with instant feedback regarding the health of the network.

Networks become complex very quickly. Problems inevitably happen and if they are not fixed in a timely manner it can lead to large scale losses for the company. In order to respond quickly certain information should preferably be at hand; what is wrong? Where is the problem? Who is affected?

Trying to document and then keep that documentation up to date is a real challenge even for the largest and most process driven company. Network topologies can change on a daily basis and it can be very difficult to ensure that the documentation reflects the current state of the network without a dedicated member of staff to manually update it.

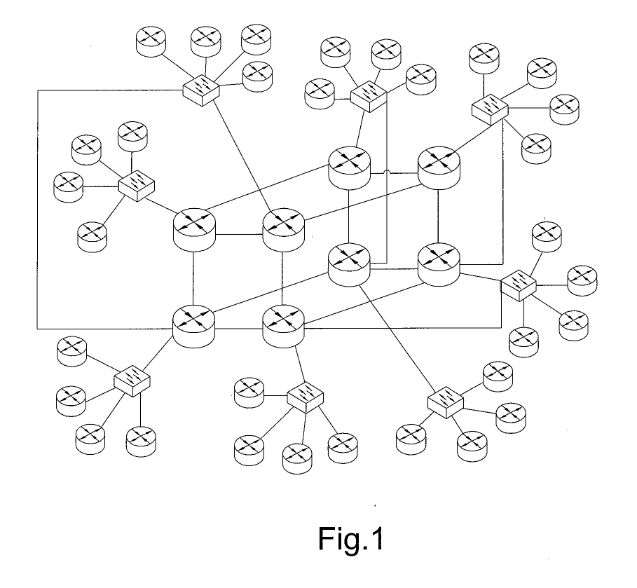

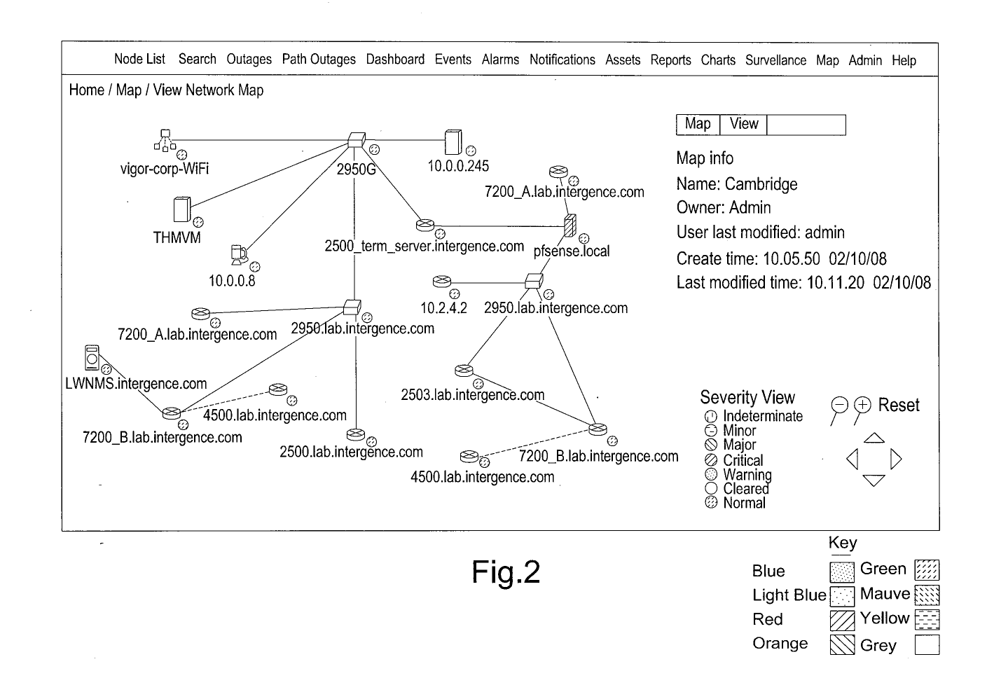

Most network operations groups keep network diagrams in Microsoft Visio format (see FIG. 1 for an example). Whilst Visio is an excellent program, it is hard to represent complex networks in an easily readable manner. Keeping the diagram up to date is also a real issue, outdated network diagrams cause delay and sometimes even more outages. Engineers rely on this documentation when performing network upgrades and maintenance so it is important that it presents a true up to date picture of the network.

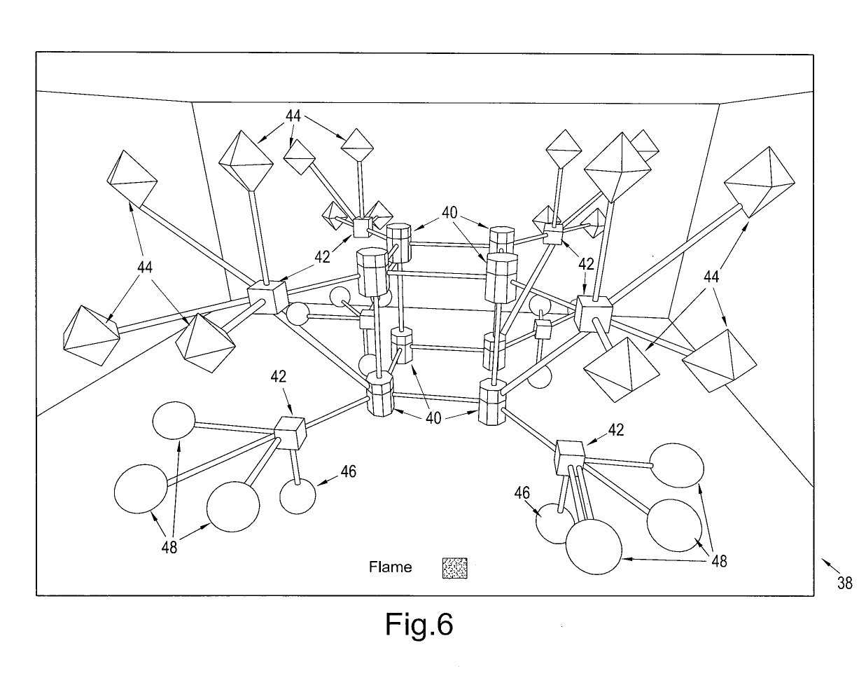

Our software takes a real time network and convert it into 3D to enhance understanding and enable the network operator to more quickly maintain, fix and optimise their network. To achieve this, the network is first be mapped in 2D and then devices in the network are positioned into the 3D space (FIG. 6).

### 3D Software Layout and Usage

All software should be intuitive to use and require minimal training. This is unfortunately not the case in the vast majority of applications. This software should preferably endeavour to be both intuitive and have a very quick time before the user is useful. One key aspect of this software is that the GUI should preferably have the same controls as many PC games. 3D PC games control has become standardised over time and most operational staff should preferably be very familiar with the navigation. Both the keyboard and mouse are used for navigating around the 3D model.

The keys W, A, D, S are used for forward, left, right and backwards respectively, the mouse is used for looking around in the 3D world.

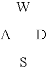

A summary of the features this software should preferably have follows:
3D Navigation using keyboard and mouse using the same format as many popular games
Cross hairs to select the required item
Different shapes represent different types of device or vendor (i.e.)
   Router 40—Octagonal Prism
   Switch—42 Cube
   Firewall 44—octahedron
   Host 46—Ball (different colours for different operating systems)
   Server 48—Larger ball (different colours for different operating systems)
Left click or right click should preferably have different functions
Mouse gestures should preferably have different functions
Selecting and moving a device connector into a specified box positioned at the top of the screen should preferably enable a function (backup, add to firewall rule etc)
Visual filters should preferably enable certain information to become prominent, these would be enabled by a key sequence or menu selection
Links between devices represent network connections, different colours/visual effects/size show how congested the link is.
Application flows should preferably be directly shown in the connector, each different type of traffic (FTP, HTTP, Video, VoIP) should preferably have a different colour/visual effect.

### Reactive Views

Network Operations Centres (NOC) staff usually have a network map projected onto a wall or on their screen in order to see the status of the network at any given time. These maps are usually static apart from a few flashing icons that don't really give an indication of what is wrong.

With the 3D network diagram, animations can be used to clearly define the issue. As each device is multi faceted, each facet can have different information or the whole device can be lit up.

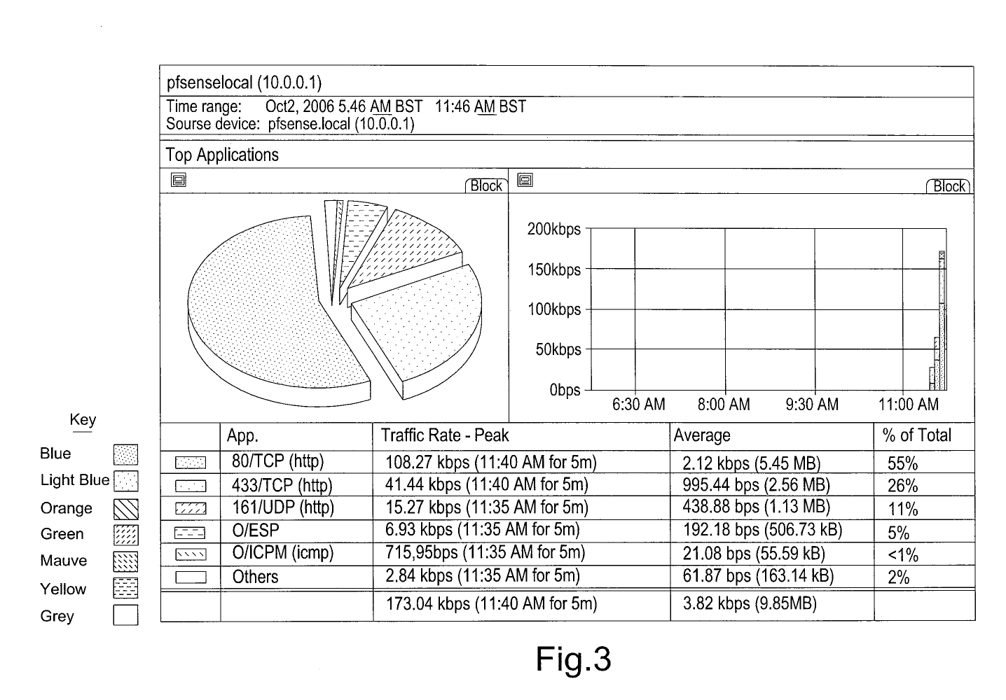

As the traditional 2D maps are static (see, for example, FIG. 3), operational staff rarely look at them and sometimes miss important events. This software should preferably have the capability to automatically fly through the map, thus inviting interest and increasing the likelihood of staff noticing events or even picking up trends.

The software should preferably zero in on trouble devices and apply an animation/texture which clearly demonstrates that there is an issue with that device. These animations should preferably be tailored to represent the issue which that device is experiencing. The display can be customised to specific views such as environmental factors, link utilisation or performance data with healthy devices being greyed out so the user can clearly identify the objects which are experiencing problems.

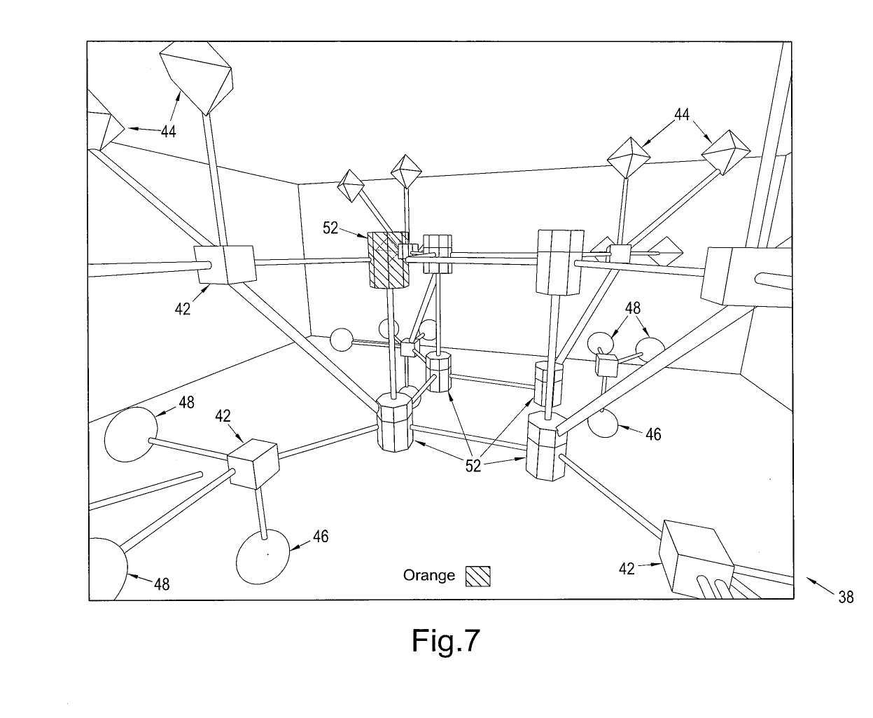

FIG. 7 shows an example of a device with hot environmentals (in this case a router 52). The whole device has been overlaid with a burning animation to indicate this. With this view it is immediately obvious to the user that there is a problem associated with the device and through the flame animation they can see that this problem is related to the devices environmental thresholds being exceeded.

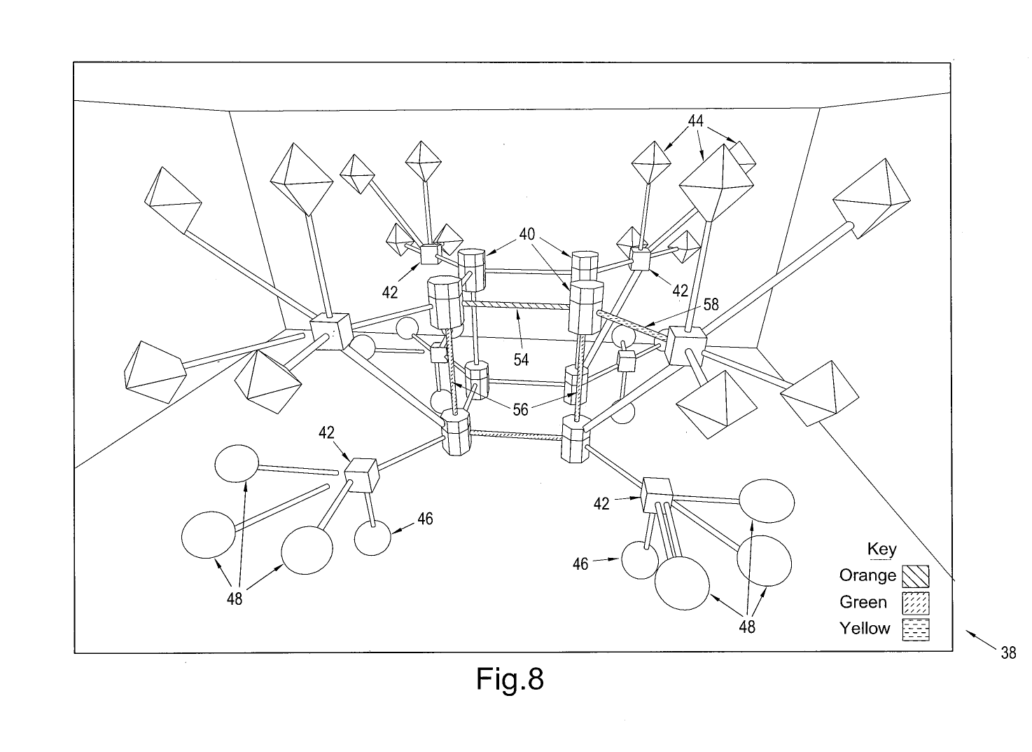

Underused/overused links or devices can be singled out easily by applying a visual effect. FIG. 8 shows an example where the links show either over utilisation or utilisation within threshold. The over utilised links 54 are shown in orange and the correctly utilised links 56 in green. Links 58 which are approaching the utilisation threshold are shown in yellow.

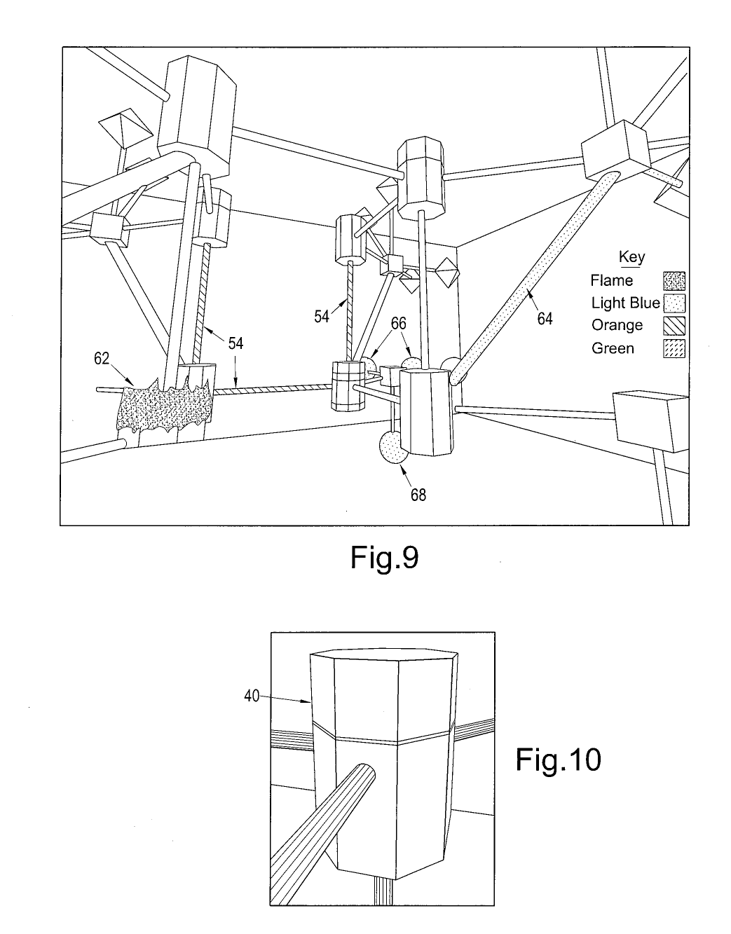

Information can be overlaid onto the base diagram so multiple metrics may be analysed at once. For example as shown in FIG. 9 multiple types of environmental information may be displayed on a single diagram without causing information overload to the user. FIG. 9 shows an overutilised switch 62 with corresponding over utilised links 54 and under-utilised hosts 66 with an under-utilised server 68 and under utilised links 64.

FIG. 5 shows that when combined these views shows a comprehensive network view enabling operations staff to react quickly and gain the information they need to fix the issue more rapidly than traditionally possible.

### Troubleshooting

Fixing problems is about having the correct information at hand so you can deduce what is causing the issue. Currently the information needed is found in disparate places, in spreadsheets, diagrams, network management systems and on the device itself. Having all the relevant information in one place and easy to access and interpret saves time and therefore saves money.

One feature which enhances the ease of troubleshooting is multi faceted device representations with each facet containing different information. When a device is selected to open it should preferably unveil to show different information on each 2D plane which constructs the object. The information should preferably include relevant information on the device and could include graphs and statistics on CPU, interfaces, logs, errors and have a console connection to directly integrate the device. All in one place.

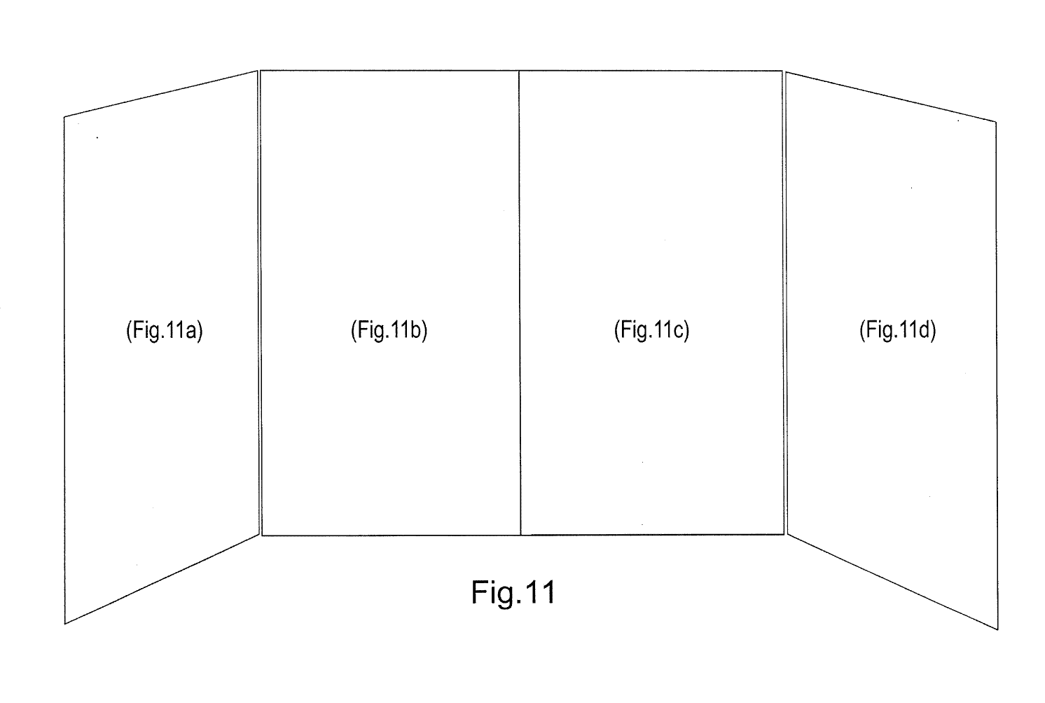

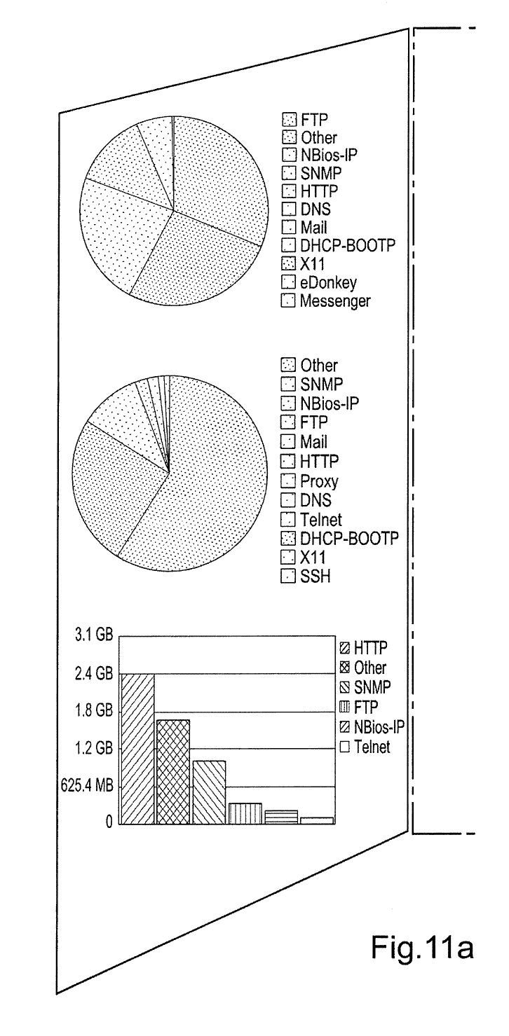

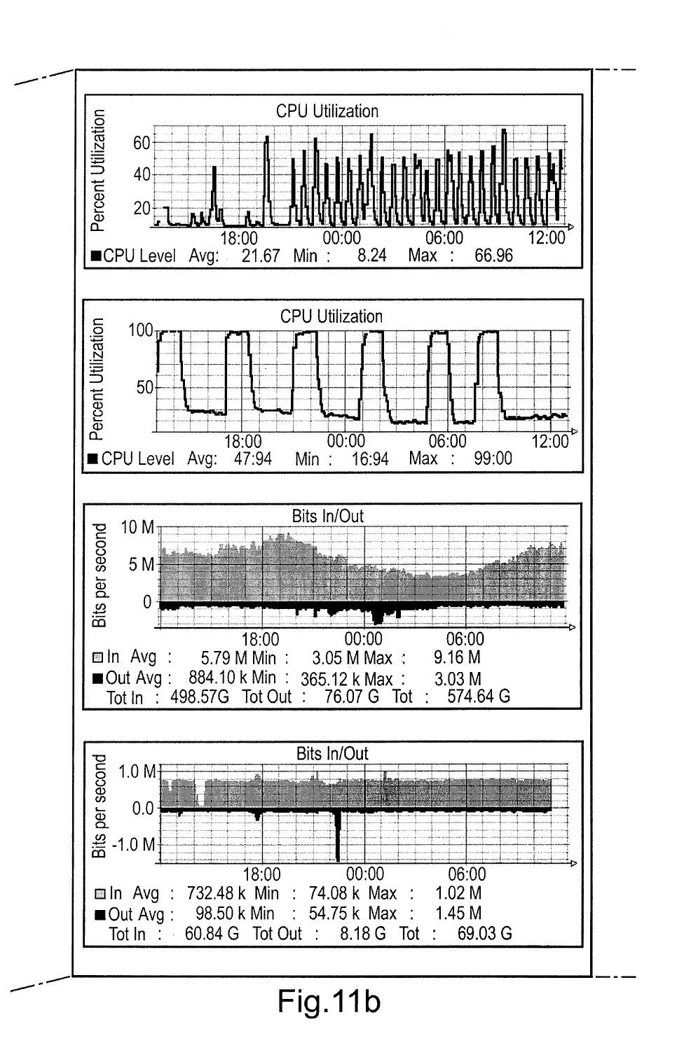

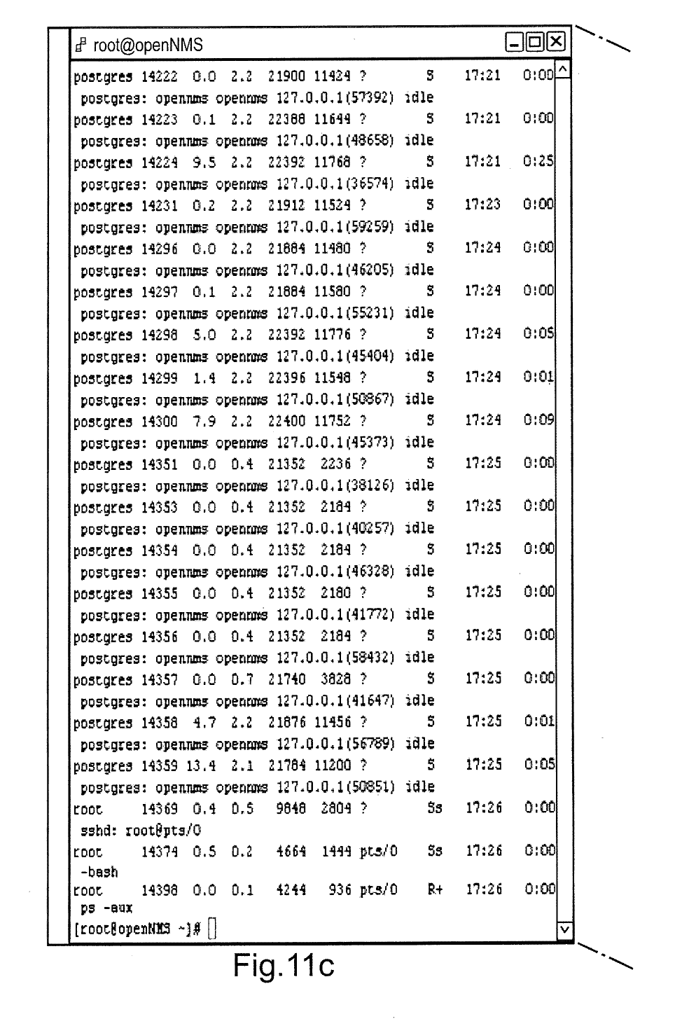

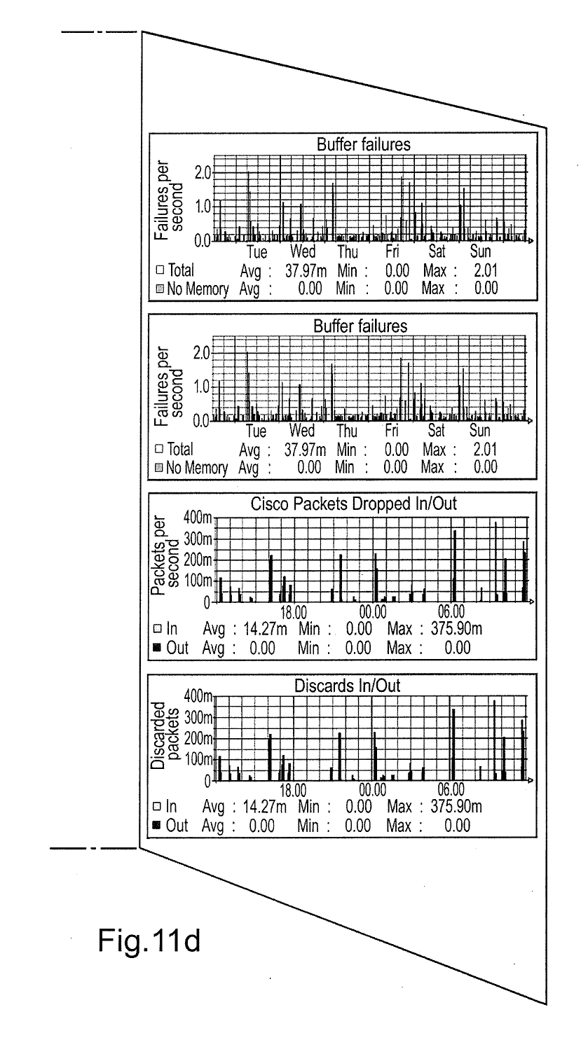

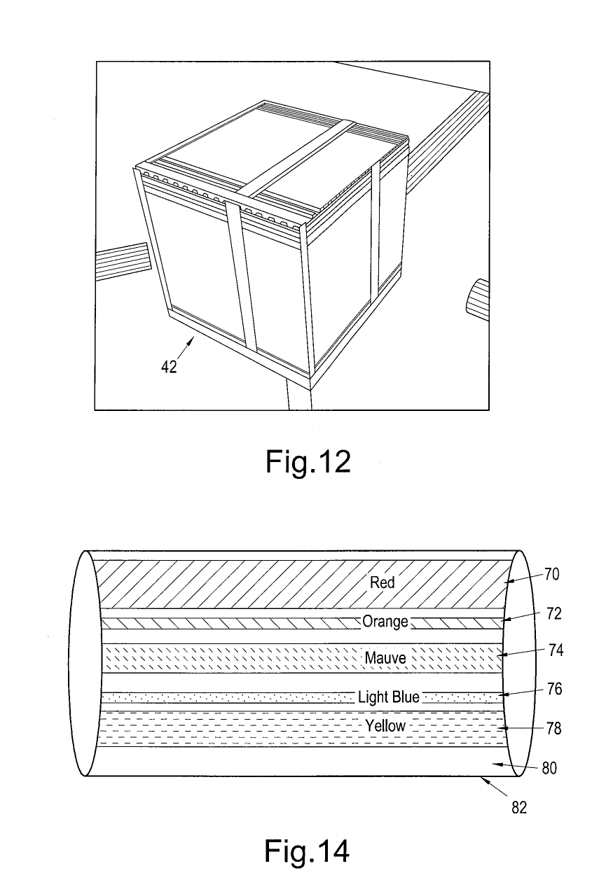

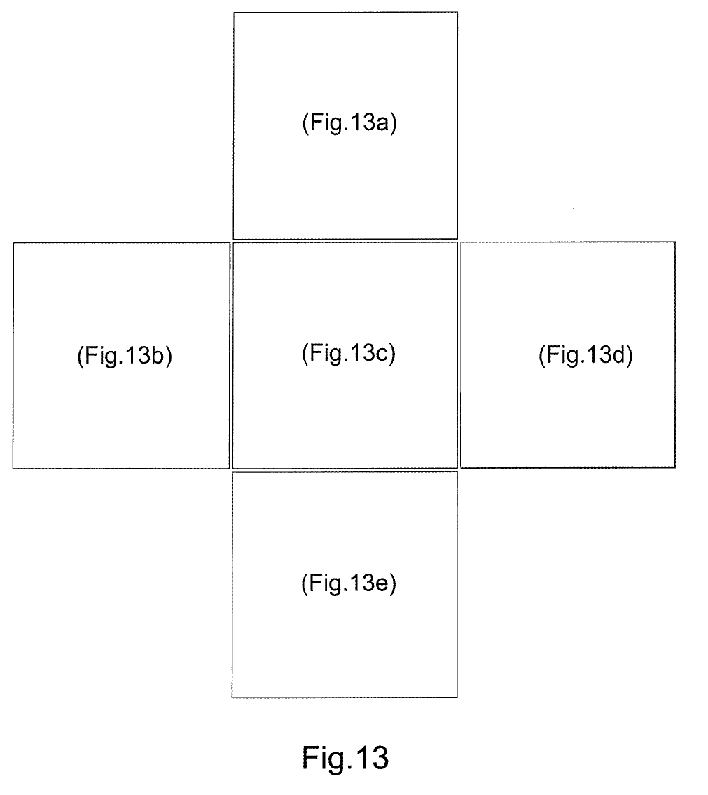

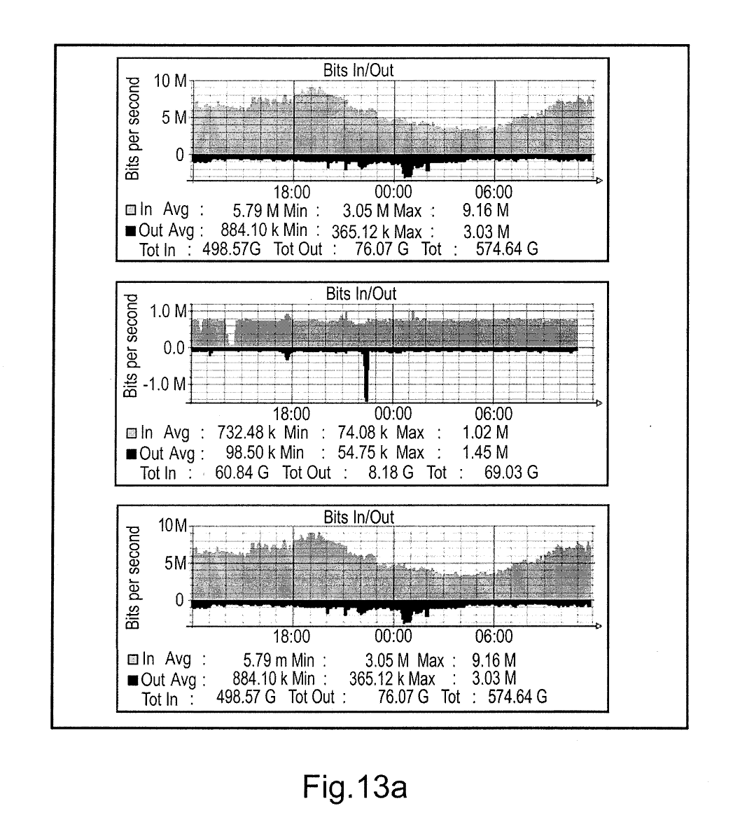

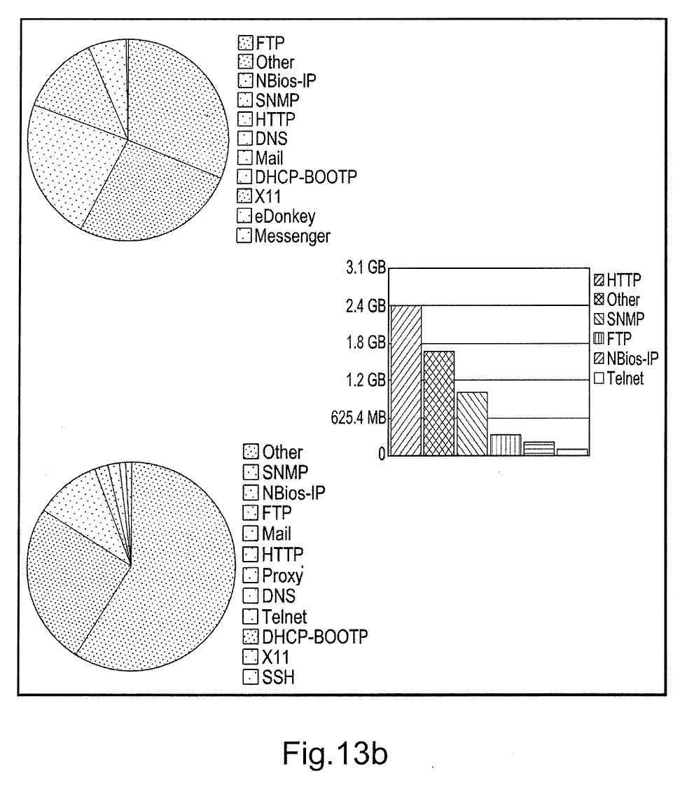

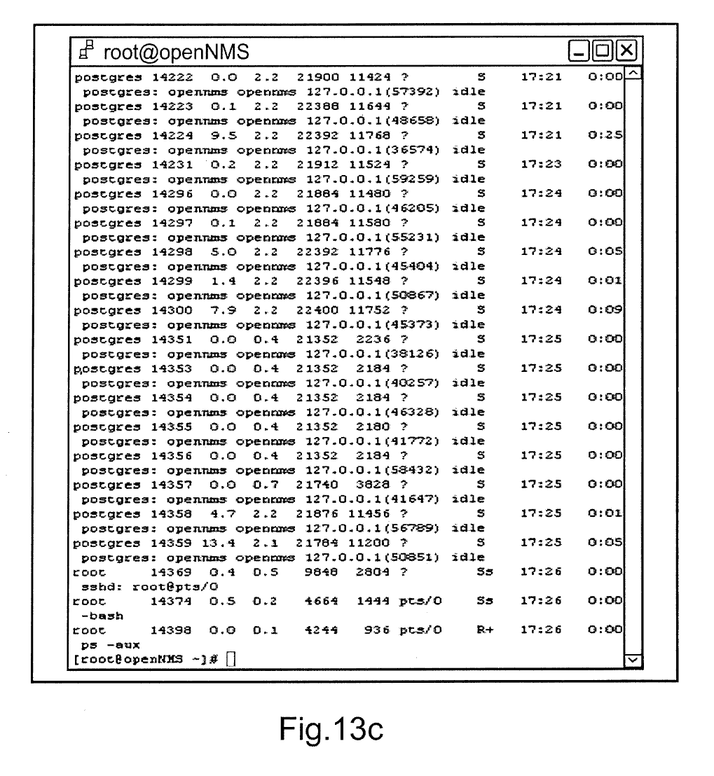

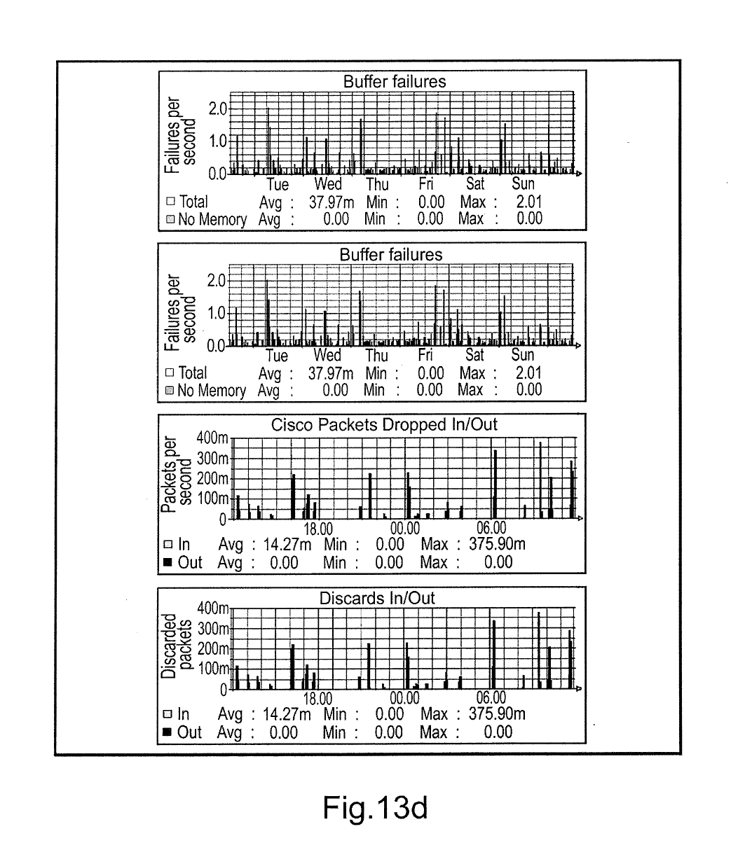

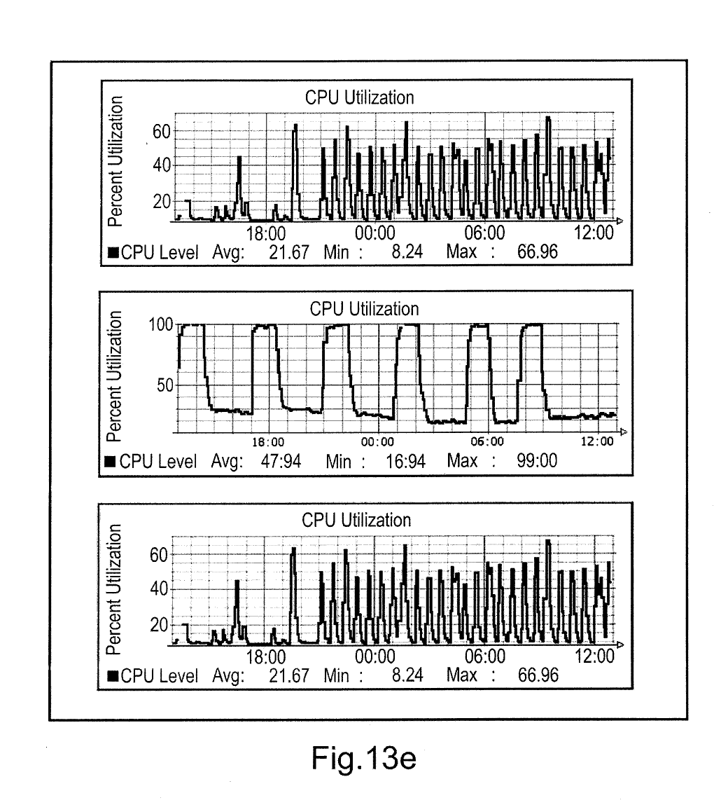

For example, in FIGS. 10 to 13 are two representations of devices. FIG. 10 shows an octagonal shape, e.g. a router 40, that opens up as shown in FIG. 11 to show detailed information on the performance of the device. FIG. 12 shows a cube (e.g. a switch 42) which opens up as shown in FIG. 13 to show detailed information on the performance of the device. Of course the information should preferably be customisable to include any data, graph or analysis in the database. Interfaces can be embedded into the device object to allow the user to have direct access to the console or other interface (Java, Web client etc).

### Capacity Management

Making the most of any asset is prudent. Good capacity management can save a company large sums and also increase the end customer's experience. Most companies only look at capacity when people start to complain of poor response times and outages. As shown in FIG. 14, each link in the 3D diagram can have different colours and widths representing different types of traffic (70, 72, 74, 76, 78) and the corresponding bandwidth usage. The outside covering 82 can be coloured and semi transparent to indicate an overall bandwidth threshold.

Example colour definitions as shown in FIG. 14:
RED—FTP 70
Orange—TFTP 72
Mauve—HTTP 74
Light Blue—Unknown 76
Yellow—VoIP 78
Blank space—spare capacity 80
Connector outside colour 82—Threshold (i.e. Green 20%-60%, orange 61%-80%, Red 81%-100%)

Application flows per application, server, host or even session could be shown in near real time for troubleshooting, capacity planning or routing optimisation.

### Network Design, Adds/Moves/Changes

This tool can be matched up with networking simulation software so you could add capacity, links, change routing, remove devices and the like and see the result on the 3D map.

### Trending

Being able to accurately predict usage for things such as bandwidth, CPU, storage space etc is a very important thing. The 3D software can visualise the trends and give a holistic view over the entire network enabling just in time replacement, more uptime and better SLA overall.

Animations can be set up to trend network usage across weeks, months, years and can show the network getting more and more congested over time.

### Application Performance

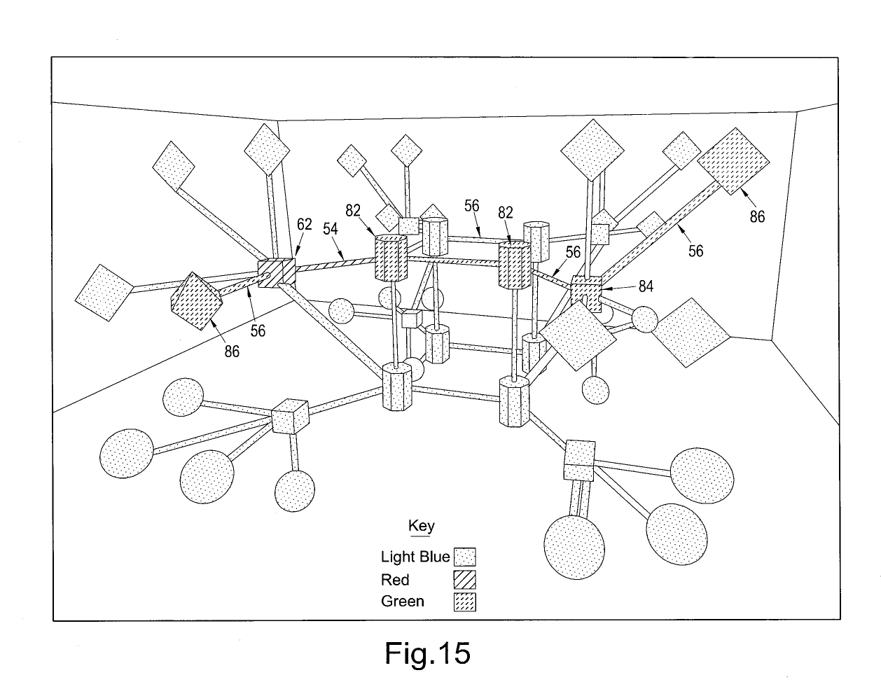

SLA measurement and visualisation and application performance views are preferably provided, as described earlier. The illustration of FIG. 15 illustrates the implementation and shows one link 54 and associated switch 62 above threshold which is shown in red. The rest of the path (i.e. firewall 86 and its link 56 to the switch, then router 82 through link 56 to next router 82 through a link 56 to a switch 84 and through a final link 56 to the firewall 86) is within threshold and shown in green.

### Asset Management

RFID can be used to locate and position devices and racks in a data centre. The software could then build an accurate, real time 3D representation of the physical location of all devices. Since the software has already mapped the connection between devices it could add these connections to the 3D representation. All this could be used for audit and asset management. Real time troubleshooting and assistance for data centre staff is enhanced as they can have a real time, accurate cable diagram.

### Replay

When trying to track down issues or spot trends it is often helpful to see what has happened in the past. The software should preferably have the facility to replay time at different speeds. Preferred embodiments can show how the topology of the network has changed over time.

### Routing Protocols

Most medium and all large networks run some kind of routing protocol. Configuring and optimising these routing protocols is a task that requires expert skill and experience. Maintaining the routing protocol schema is rarely done well as add, moves, changes and staff turnover cause the initial design (if there is one) to degrade. Other times the company grows over time and additional devices and/or networks are added in an ad-hoc way. Good configuration is important as redundancy can be compromised if the configuration is not optimal. Visualising routing protocol operation and configuration is difficult but with 3D visualisation it becomes clear what is configured and if anything does not come up to specification.

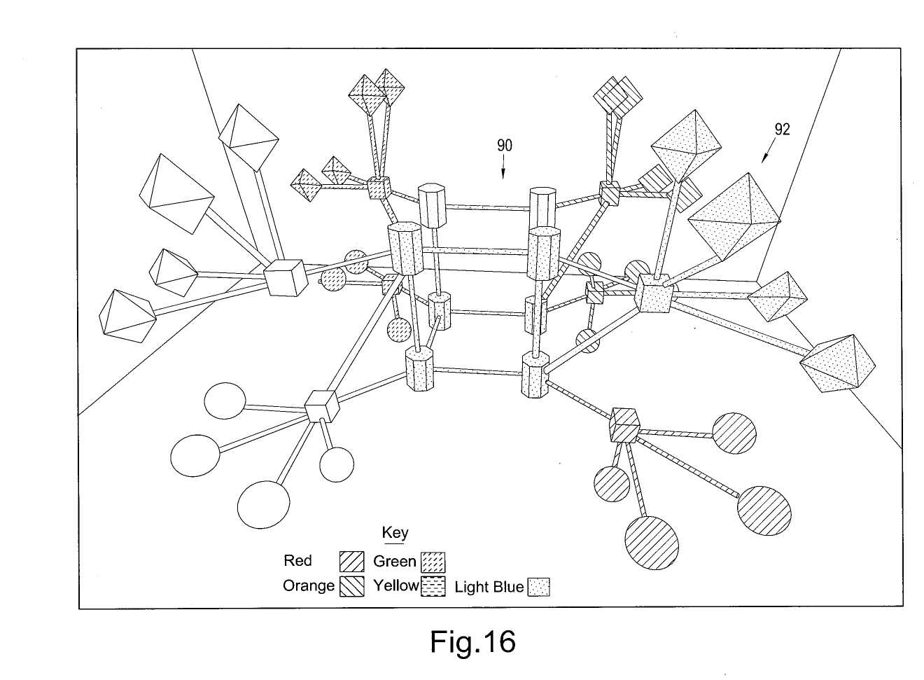

In FIG. 16 is an illustration of the configuration of routing protocol Open Shortest Path First (OSPF). OSPF allows for the definition of areas to make routing more efficient and reduce resource usage. One can clearly see that one part of the network does not adhere to the network norm. The central area 90 comprising eight octahedrons and connecting links is illustrated in blue (light coloured) and branches out to one area of the network 92 which is also coloured light blue. All the other parts of the network are segmented and shown with different colours/patterns.

### Application Path Analysis and Optimisation

Managing the path a flow takes across the network has become more common in order to make the best use of bandwidth, decrease latency and jitter and defining classes of service. This software should preferably enable the viewing and optimisation of network routing by visualising the actual path taken by traffic. It should preferably be clear what path is taken and what devices are using certain applications.

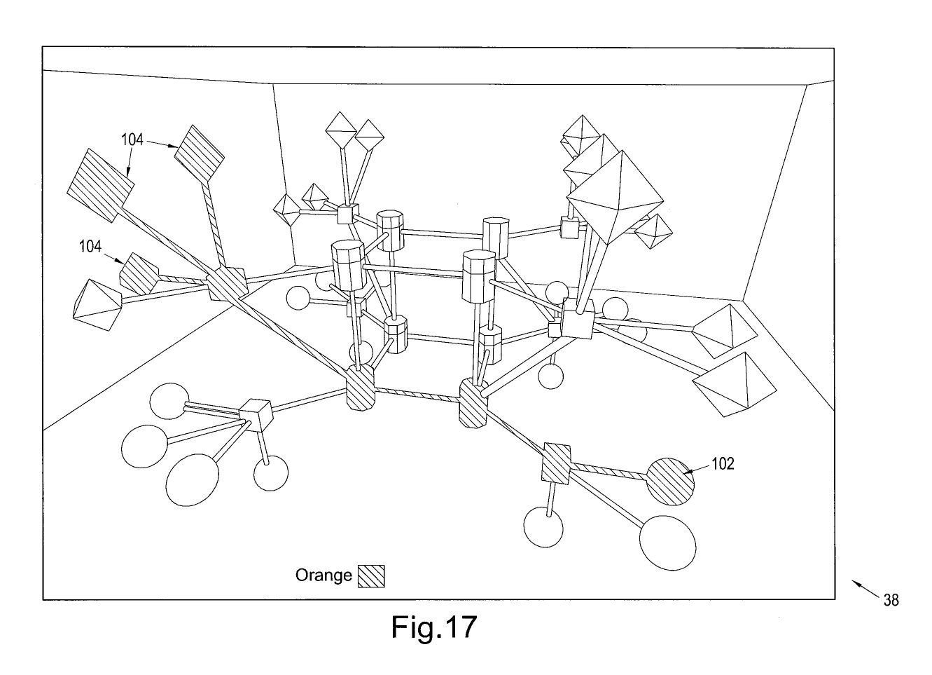

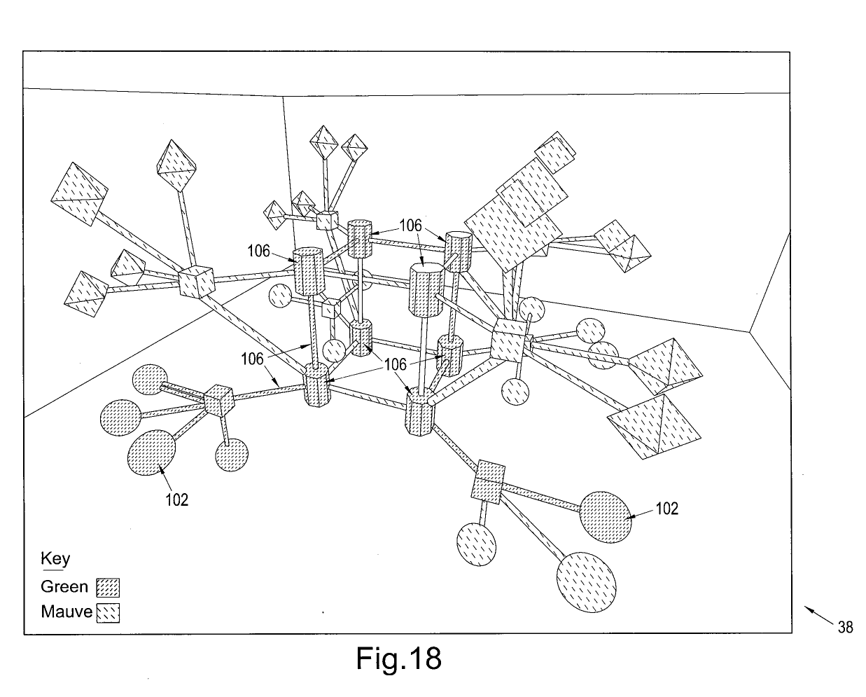

FIG. 17 shows a representation of an application path. The server 102 on the right represented by a sphere is serving three clients 104 on the left represented by three octahedrons. The application path of links and routers is shown in the same colour as the server and clients. FIG. 18 shows a routing path illustrated in green (light coloured) from a server 102 on the right represented by a sphere to a server 102 and three hosts on the left. As can be seen it is sub-optimal because it is not the most direct path but passes through six of the eight routers 106 on the network. The most direct path would require routing through only two routers.

### Power Usage/Optimal Usage

Power usage and space is a major concern for all data centres. Reducing both power and physical space requires a detailed view on the current loading of current assets. Being able to see which devices are being optimally utilised and which can be retired or consolidated should preferably potentially save companies massive cost.

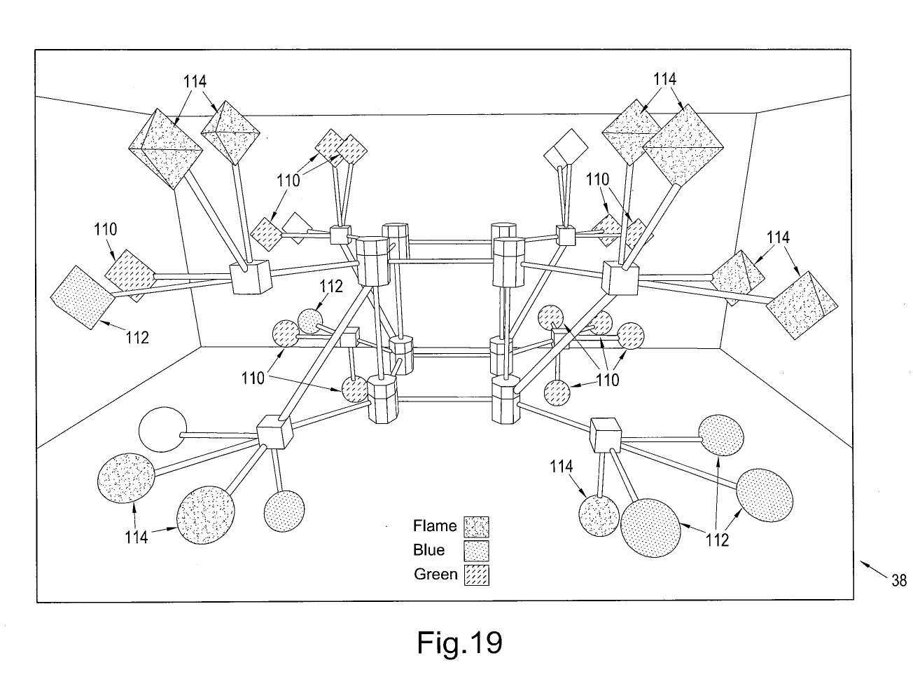

The software should preferably use statistics gathered including CPU usage, power drain (if available) and bandwidth usage to determine a device's level of optimal usage or non use. It should preferably then colour the map to reflect this. It should preferably be easy to see individual devices or whole areas not being utilised effectively. FIG. 19 illustrates 3 states of devices; the compliant devices 110 are coloured green, the under utilised devices 112 are coloured blue and the over utilised devices 114 are coloured fire.

### Virtual Server View

Virtualisation technology has become mainstream over the last few years, this has reduced costs but also increased complexity and brought on redundancy challenges. If the hardware fails it can affect many virtual servers.

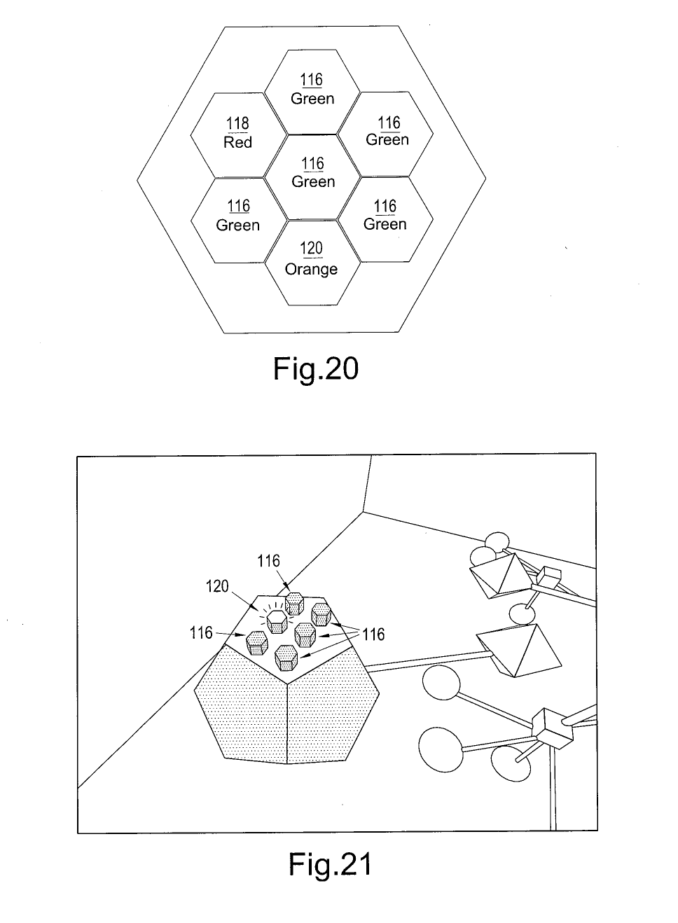

Visualising virtual servers is a hard task as the number of virtual instances increases. The software represents virtual servers as hexagonal prisms on each facet of the server shape (FIG. 20 shows one such side of the server shape on which there are seven virtual servers 116, 118, 120). This would allow many virtual servers to be shown at one time. Different colours (e.g. green 116, red 118 or orange 120) and/or animations should preferably distinguish different instance states. An alert preferably causes an individual hexagon to light up, for example amber or orange coloured as virtual server 120. It should preferably be easy to distinguish issues.

When a virtual server is selected the hexagonal prism should preferably rise out of the server shape like a rod coming out of a nuclear reactor. It should preferably then open up into a display similar to the troubleshooting display detailed above. FIG. 21 shows a representation of a server with six virtual instances 116, 120. One virtual server 120 has an alert.

### Multi-Touch Screen Interface

The combination of an interactive multi touch large screen and our software facilitates intuitive use, eye catching demonstrations at trade shows and for potential customers/investors. One example source of this technology is MultiTouch, a Helsinki, Finland based company (http://www.multitouch.fi/).

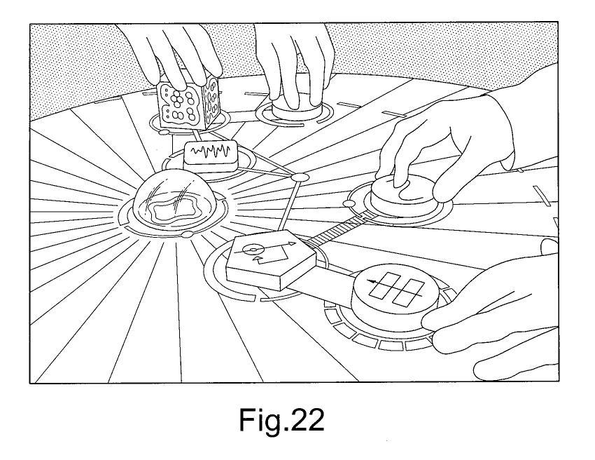

This technology may be used, for example, in trending and capacity management. Using Multi Touch screen technology the 3D map can be able to be manipulated in a way that enhances troubleshooting, capacity management and network design (FIG. 22). Such a multi-touch user interface allows a user to manipulate the 3D map by simultaneously touching said touch screen in two or more different places. Such touches can perform one or more of translation, scaling and rotation of elements within said 3D representation of said network whereby the performance of the network may be optimised.

### Pattern Recognition

Filters may be applied to the 3D network map so that operations staff are better able to recognise patterns and therefore able be more proactive with the management and control of the network.

### 2D Visualisation

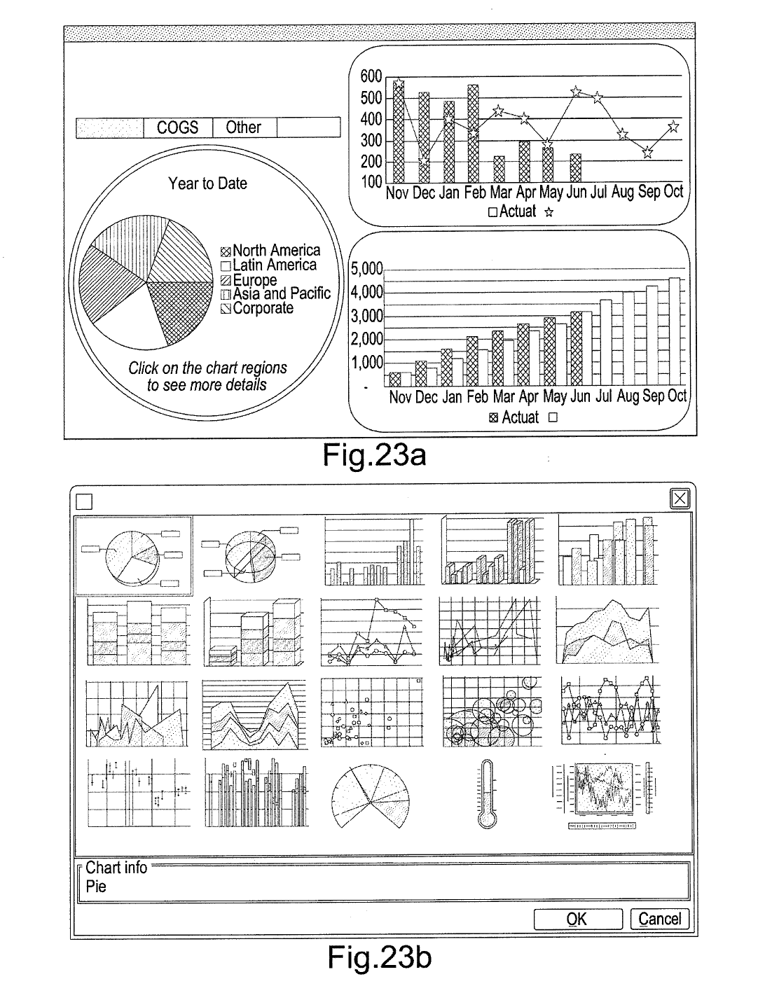

Visualising the network is in 3D very valuable but there may also be a traditional reporting and graphing function alongside the 3D display. We have the information in a database and it is easy to visualise this data using both open source and proprietary software such as Crystal reports or Jasperforge (FIGS. 23a and 23b). Thus there is preferably a reporting function that preferably creates both ad hoc and scheduled graphs, spreadsheets and charts.

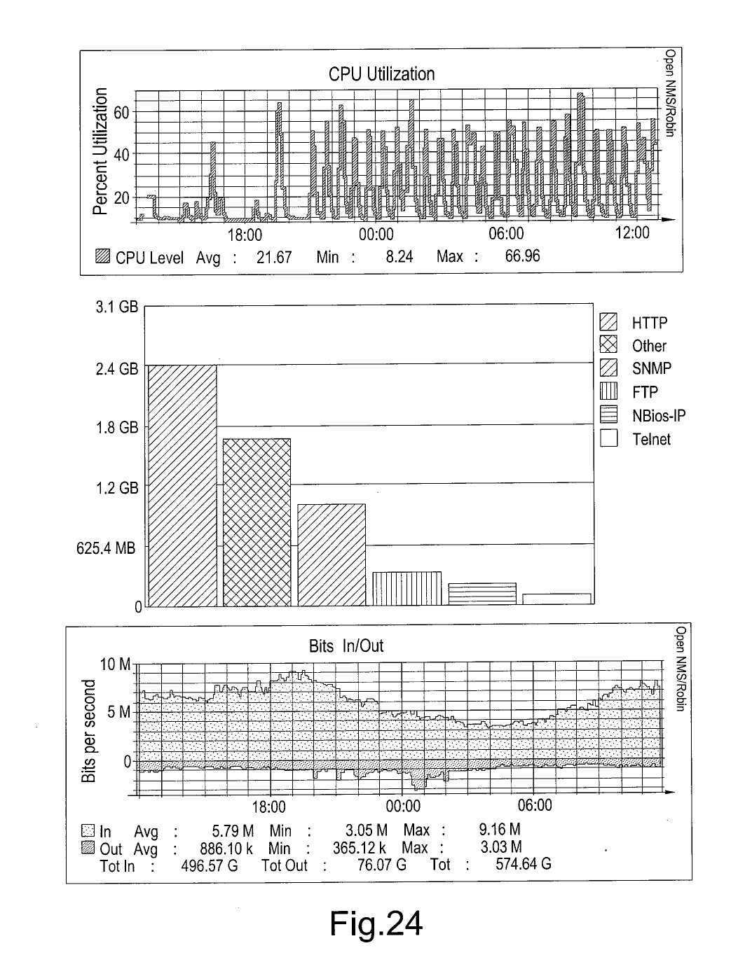

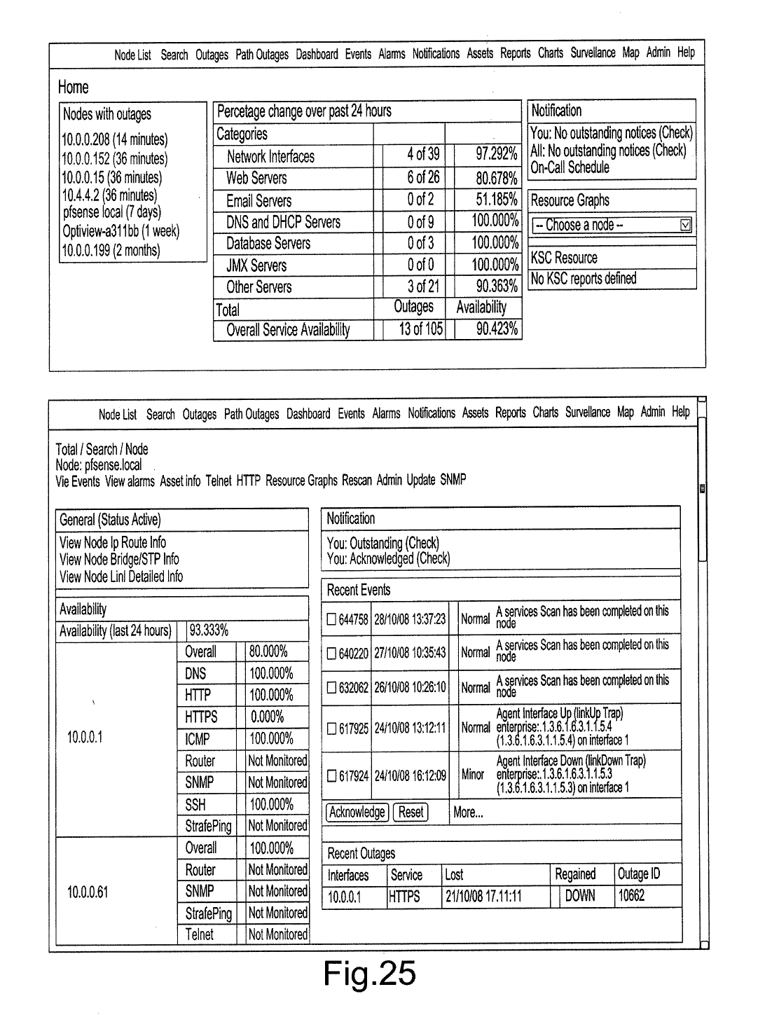

Traditional monitoring views are useful in some circumstances. Thus the software should preferably display these via a HTML page, possibly with AJAX to enhance usability. These views can then be used in the 3D product as well to give a better overall view. Thus graphs and information should preferably be available, for example as shown in the examples in FIGS. 24 and 25. These Figures may be incorporated in the fold-out views of devices as shown in FIGS. 11 and 13.

### Software Architecture

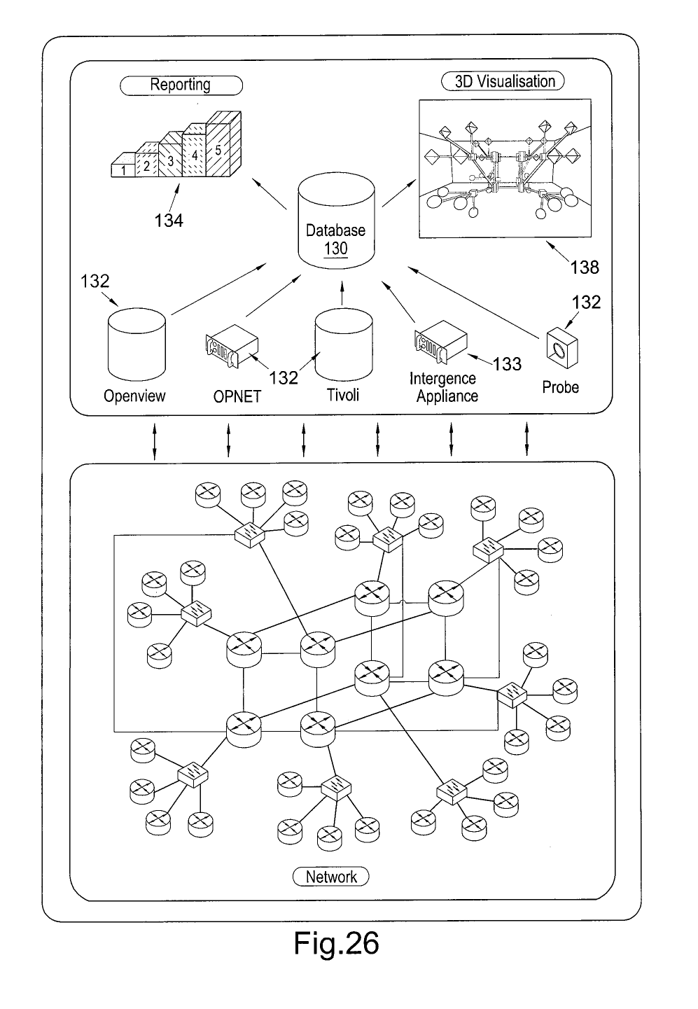

In order to visualise the network 136 and the data flowing over it information should preferably firstly be gathered, analysed and stored. Referring to FIG. 26, a central database 130 is preferably the centre of all information storage. All information, whether that be from Intergence software/hardware 133 or other external software/hardware devices 132 should preferably be transferred to this central database for data mining and use. The data mining may include generating reports using a reporting engine 134 or providing 3D Visualisation as described above by a 3D Visualisation module 138.

Reports are important to both the customer and Intergence staff to aid interpretation of data. The reporting engine 134 should preferably be able to produce both graphical and CVS files that can be output to spreadsheets. It should preferably also be able to produce PDF files. It should preferably be able to utilise SQL, CVS and flat file data

Certain information is employed in order to display, manage and analyse the network. The information used in embodiments of the system includes: Static information (i.e. IP addresses, Host names, Vendor, Type of device, Model, CPU type, CPU speed, HD capacity, RAM installed, Hardware modules installed, Serial Numbers (chassis, modules, cards, interface modules), Interfaces (Type, Capacity), Orderable Part Numbers, Firmware installed, Operating systems, File system details, Location, Contact, Chassis ID) and Dynamic information (i.e. CPU usage, RAM usage, Interface usage, HD space usage, Memory usage, Buffer misses, Buffer failures, Interface status, Interface statistics, Routing table, Uptime, Environmental statistics, Application flows)

### Information Gathering Methods

In order to collect the desired information standardised technologies should preferably be utilised such as Simple Network Management Protocol (SNMP) and Netflow as well as some non standardised such as native CLI access.

The methods used are SNMP (poll/Trap), CLI (Telnet/SSH), Netflow, Packet capture (sniffer) and/or 3^{rd} party database import.

### Software Modules

To collect and store the data needed software applications and hardware devices may employ Open Source software, off the shelf software, or specially written software or a combination of these. There is much good software already written that can be used, both open source and closed.

### Core—Database

The database should preferably be the hub of the application suite. It may be scalable, quick and run on Linux. The information may encompass all aspects of the network, including but not limited to:

Network device configuration files

(i.e. Interface statistics, CPU load, Memory usage, Syslog information, SNMP Traps, MAC address information, ARP, Routing tables, Process information, Environmental information, Spanning Tree, Chassis inventory information, Software information, Physical Location Details, Netflow data)

SNMP software which
Retrieves information from an SNMP-capable device, either using single requests (snmpget, snmpgetnext), or multiple requests (snmpwalk, snmptable, snmpdelta).
Manipulates configuration information on an SNMP-capable device (snmpget).
Retrieves a fixed collection of information from an SNMP-capable device (snmpdf, snmpnetstat, snmpstatus).
Converts between numerical and textual forms of MIB OIDs, and displays MIB content and structure (snmptranslate).

SNMPTrap Daemon

This receives the SNMP traps/Informs, format them and place them into the database.

Syslog Daemon

This receives the syslog data, formats it and places it into the database.

SNMP Collection

SNMP collects the following from each device: CPU usage, Memory usage, Buffer misses, Buffer failures, Interface status, Interface statistics, Routing table, Hardware details (including Model, Type, Serial numbers, Modules installed, Orderable Part Number, Firmware, Operating system, File system details) SNMP details (including Location, Contact, Chassis ID), Uptime and Environmental statistics

Ping

In order to identify what devices are currently on the network ICMP ping is used to detect live devices. The information is stored and then passed to other applications to interrogate the device and gain required information.

SNMP Poller

This software uses SNMP to poll network devices and gain information via the SNMP protocol. Most network devices can be configured with SNMP, including servers and desktops.

SNMP Trap Receiver

Devices can be configured to use the SNMP protocol to send alerts when issues arise.

Syslog Server

System logs are a very valuable resource for troubleshooting and alerting. Most operations systems and network devices can be configured to send system logs to a server for analysis.

Netflow Collectors

Netflow is a protocol that reports packets flowing through interfaces. Netflow reports on the following packet information: IP source address, IP destination address, Source port, Destination port, Layer 3 protocol type, Class of Service, Router or switch interface, Flow timestamps to understand the life of a flow (timestamps are useful for calculating packets and bytes per second), Next hop IP addresses including BGP routing Autonomous Systems (AS), Subnet mask for the source and destination addresses to calculate prefixes and TCP flags to examine TCP handshakes. Using this information we can deduce the bandwidth used, application type and many other important network information including application performance issues.

Telnet Script

Some information can only be collected using the devices native CLI. If the device does not have SNMP configured or there is a bug in the OS code it is necessary to telnet to the device and issue “show” commands.

SSH Script

Some information can only be collected using the devices native CLI. If the device does not have SNMP configured or there is a bug in the OS code it is necessary to SSH to the device and issue “show” commands.

Packet Capture

A hardware device can record all network traffic for analysis. If Netflow cannot be configured on the device or more detailed information is needed this is a valuable way to gain data.

### Discovery and Input—Network Discovery

This should preferably use many methods to discover the network, e.g. SNMP, Telnet, SSH, CDP, Directly connected interfaces, Routing, Ping, Sniffer/Analyser information, and/or Hop by Hop telnet

Example discovery flow
1. Ping sweep using range/seed info/subnet from audit device
2. SNMP sweep using ping information
   a. Interface information
3. Telnet onto boxes and issue commands (Cisco commands shown)
   a. Show mac-address
   b. Show CDP neighbour detail
   c. Show arp
   d. Show ip route
   e. Show interface
4. Compare information to see if any new IP addresses/devices have been found
5. If outside starting ping sweep pass information back and start again
6. If inside ping sweep
7. Ping address from source device
8. Telnet IP address
9. Telnet//SSH IP address where the host was found and try to jump off from that device to the new device
10. If successful do show commands and analyse the results

Database Interface

This module enables interaction with modules, whether 3^{rd} party or not. This module should preferably be enabled for most common connectivity solutions including SOAP and XML. The interface should preferably have a common, standardised, configuration schema and enable plug-in type functionality. This should preferably give flexibility to use small scripts or large 3^{rd} party software suites with equal ease. The database interface should also cater for data replication and backup services between diverse instances of the server for HA and disaster recovery purposes.

Configuration Grabber

This should preferably be used for configuration management. It should preferably periodically get configurations, add them to the database and then diff the last configurations. If there are differences it should preferably check with the change management to see if it should have changed. If the change management has no record of this an alert should preferably be sent. The reverse should preferably also be true of this tool to enable the reconfiguration of a device from a last-known good configuration.

Command Grabber

This should preferably use telnet/SSH to logon to a network device, issue and capture the output of CLI commands and then populate the database. This should preferably be used by most modules and for many purposes, including but not restricted to ????? This should preferably be useful when devices do now have SNMP installed, a SNMP MID has not been written to gain the required information or a bug in the operating system restricts use of SNMP.

Network Discovery Helper

This software should preferably be installed on a client machine to allow firewall penetration. One can also place cheap laptops like the ASUS EEE laptop into the network. They are cheap, small and run Linux. The Main module should preferably use this client to bounce SNMP/Telnet requests via the client. This should preferably be used for firewall/policy penetration. It could also be used for remote sites with limited bandwidth i.e. the client software could keep all discovery information in a local database and email to the main module. This could also be used as a system to aid in collection of network availability statistics by hosting a probe module or acting as a local storage for multiple probe statistics.

Sniffer/Analyser Location Adviser

This should preferably indicate where sniffers should be located for optimum usability. This should preferably require at least one sniffer in the network to analyse flows to analyse client/server flows.

Server Reporting Agent

This software, written in Java, should preferably be installed on servers to gain information that is impossible using SNMP. It should preferably be able to communicate directly with the server OS and the running applications and should preferably be able to transfer the information gained to an Intergence device using either SNMP (versions 1 to 3) or secure FTP.

### Analysis:

Client and Server Location Reporter

This module should preferably map Servers and Clients to what routers/switches/ports they are connected to. It should preferably report on Router/Switch connected to, Connected port on router/switch, VLAN, MAC address, DNS name, IP address, Netbios name and/or Traffic usage. It should preferably use MAC, ARP, DNS, VLAN, Ping etc to discover. One can use Telnet/SSH not SNMP as polling switches for large ARP/MAC tables can cause high CPU if there are a large number.

Capacity Management

This should preferably check for overload situations and calculate trends. It should preferably use SNMP interface statistics, QOS queue counter statistics “show service-policy interface”, ‘Show interface’ command and flow information from the analyser to calculate the usage reports. Event correlation may be performed to see if any anomalous capacity statistics are due to failure events on the network.

LAN/WAN Traffic Sniffer/Analyser

This should preferably be used to capture and analyse network traffic. The information gathered and analysed should preferably be used by the Optimisation, SLA, Capacity, Network Security Penetration Detection, Network Discovery and reporting modules. It should preferably also be able to interpret NetFlow streams and Cisco SAA/IP SLA. It should preferably probably run on Linux on a 1U server. These servers (there is usually more than one) should preferably be strategically placed in the network after the audit. There should preferably be at least two separate versions, a LAN specific and a WAN specific. The LAN version only needs two Ethernet interfaces, one for monitoring and one for management. The WAN version may need E1, oC3 or Ethernet. The WAN version should preferably be placed in-line with the provider's link so should preferably then be transparent to both the customer and the provider. Both versions should preferably be highly secure and impervious to hacker attack.

Application Profiling

This should preferably use the sniffer and Netflow output to intelligently analyse application flows; it should preferably report on Bandwidth used per application, Latency/jitter for applications, End point usage, Protocol usage and/or Rouge applications (Torrent, News etc).

Asset Identification and Reporting

This should preferably use the information gathered during the audit to identify location, hostnames, serial numbers, RAM, HD, Module types, and software revisions of the network devices. It should preferably categorise, list and report on these assets. The asset identification module should also allow for the assignment of user defined/automatically assign asset serial numbers for tracking. This information should be available to output in such a way to provide physical asset labelling on devices.

OS Verification and Audit

This should preferably record check on maintenance and licensing agreements for devices/OS and notify on approach and breach of these licensing periods. The ability to add the vendor contact details relating to the licensing should also be part of the database information.

Bug Scrub

This should preferably compare known bugs in OS with the versions of OS in the database. Obtaining a definitive listing of all OS bugs can be difficult but in embodiments this is not essential.

EoL/EoS (End of Life/End of Support)

This should preferably check all devices, modules and OS for EoL/EoS. The EoL/EoS database should preferably have to be updated regularly.

Optimisation Engine

This module/software should preferably be able to take input from the database directly or via some kind of application data sharing paradigm CVS, SOAP etc. It should preferably be able to model the network, graphically if possible, and highlight, eg. Single points of failure and/or Down stream choke points from failure scenarios

SLA Measurement

This should preferably use the sniffer capture, as well as applications such as Cisco's SAA/IP SLA information, to analyse and report on application/3^{rd} party SLA measurements.

Network Diagram 2D Visualization

This module should preferably use the information in the database to create accurate, detailed, easily read diagrams. They should preferably be easily exported into Microsoft Visio® and should preferably have the following information in layers: Host name, Device type, Interface type, IP addresses, MAC addresses, Routing protocol (coverage, type, id) and VLAN membership and coverage.

Network 3D Visualization

This module should preferably use 3D tools to first build a 3D representation of the network which is then used to visualise in real time the current status of the network. This module comprises three main components, namely 3D network creation, data filtering and display and is described in more detail below.

Syslog/Log Analyser

This should preferably analyse syslog, log, or crashinfo information (captured by the command grabber) and report/alert for any problems on the device/network.

Intrusion Detection System

This module should preferably use the sniffer data and report/alert on suspicious traffic.

This module would work closely with the traffic sniffer module. We anticipate using SNORT http://www.snort.org/.

Configuration Parser

This should preferably check the network device for common mis-configuration and should preferably also suggest best practice. It should preferably look at both configuration files and output from show commands.

Routing/Routing Protocol Analyser

This should preferably check the routing and routing configuration for problems and potential optimisations.

Environmental Analyser

This should preferably look at the voltage, ampage and temperature of the devices if available and work out the power usage per device, per rack, per room and per data centre.

Edge Device Usage Reporting

This should preferably capture MAC address information at the edge switches, eg every hour, and report on usage statistics. It can use Netbios, NFS, IP amongst other examples to name the devices (most have DHCP enabled so just pinging them may not be enough). It should preferably also connect into active directory to cover devices (PCs) that are powered on but not used. This module should preferably be used to highlight devices that can be de-commissioned or re-utilised.

Server Mapper

This module should preferably map server location and give a graphical representation of traffic flows around the network. It should preferably be able to map per Server, Application, Switch and/or Router. One can poll the ARP tables of each server to identify what devices they are talking too to get an idea of traffic flows. After that one can add probes to relevant locations.

Network Vulnerability Scanner

This software scans the network for vulnerabilities periodically and report. It may employ e.g., Nessus (http://www.nessus.org/).

Routing Protocol Peering

This should preferably peer directly with a network router running BGP, OSPF, ISIS or EIGRP and report on routing changes, errors and topology.

Trend Analysis

It is helpful to find and analyse trends for capacity management, troubleshooting and proactive monitoring. It should preferably be easier to spot trends over time, especially on a 24 hour cycle on the 3D model. The software should preferably replay analysed data on the model so correlations can be seen easily and quickly where it would have been very difficult to spot the correlations before.

Network Emulation

In order to accurately predict what effects should preferably occur when something is changed on the network the network may be simulated in software. Once this is done, add, moves and changes can be simulated and shown to a network engineer. This can be very useful for capacity management,

This module therefore should preferably:
1. Show how new or updated applications or network services should perform for remote end-users, throughout the development lifecycle.
2. Avoid production related network or application problems.
3. Ensure an optimal remote end-user experience.
4. Eliminate phased rollouts to remote end-users, and avoid a fix-as-you-go approach.
5. Make sound infrastructure investment decisions without complex field trials.
6. Troubleshoot post-production problems and verify resolution, quickly and easily.

Connecting into our 3D visualisation and using multi-touch technology it is quick and easy to predict how the network should preferably react to any changes, planned or otherwise.

ITIL Based Managed Services

This software suite covers the following ITIL based modules: Configuration management, Change management, Incident management and Asset management.

Returning to the Network 3D Visualization tool, as described above this module comprises three main components, namely 3D network creation, data filtering and display.

### 3D Network Creation

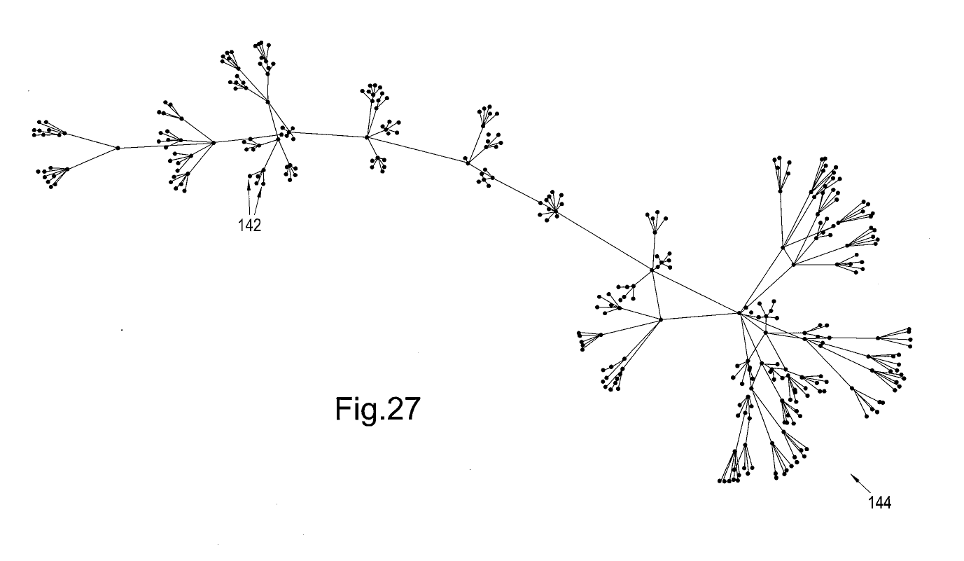

This component is responsible for laying out the nodes of the network in a 3D configuration suitable for viewing. The input comprises the topological information in the network in the form of a list of nodes and a list of links between nodes. Additional constraints on the configuration can also be applied. Based on this topological data a 3D network is created using a clustering algorithm. For example, this may comprise modelling the network as a physical set of charges and springs. The charges all repel each other, and the springs attract, resulting in a 3D layout where every node finds its own space, and connected nodes are clustered together. An example of the output from this approach is shown in FIG. 27. The output of this step is a set of 3D coordinates for each node in the network.

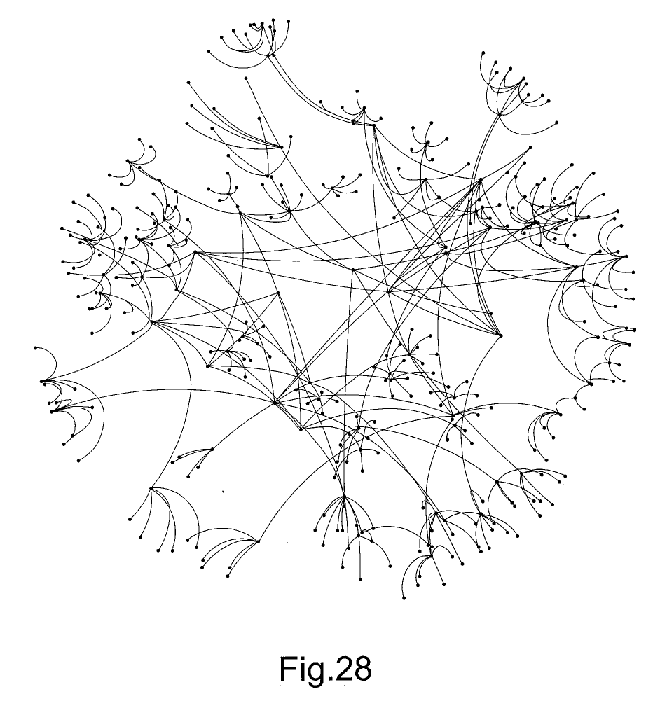

As an aid to visualisation different background geometries can be used for the clustering algorithm. For example, nested spheres can be used for a hierarchical network, with the clusterer running independently on each sphere and the nesting then achieved to minimise the stretching of springs between layers. A separate view based on the mathematics of hyperbolic geometry is also envisaged. This has the advantage of separating nodes and emphasising links, making it easier to diagnose problems with connections in the network. An example of this layout in shown in FIG. 28.

This clusterer can run on either the back-end server or the client, and will be able to react immediately to any changes in network topology. So when a new device is added to the network the clusterer re-computes the 3D layout instantly. A physics-based clusterer can achieve this speed of update, though other schemes also exist for rapid clustering.

### Data Filtering

This component is responsible for choosing what data to display on the nodes and links in the network, and how to display it. For example, filters can be set up for CPU usage, bandwidth usage, error rates etc. The data can then be displayed in a number of ways. For example, a colour scheme can be assigned to the outputs of the filtering step so that, for example, CPUs that are near maximum usage are coloured red, and CPUs that are less stressed are coloured green. This way the network monitor can view the entire network and easily pick out areas that are stressed. Similarly connections that are running at full capacity can be highlighted, allowing the operator to re-route data. As well as colour, information can be conveyed visually using motion, or a particle system. This component is provides a simple means of joining a chosen filter to a visualisation scheme.

### Display

The combined results of the network creation and filtering steps are fed into a scenegraph module. This scenegraph contains all of the nodes and links together with the colour and texture data for each component. The display component walks the scenegraph and creates a list of polygons to be rendered in the 3D viewer. The rendering step depends on the position of the viewer, allowing the operator to navigate through the network in 3D using a control system familiar from computer games.

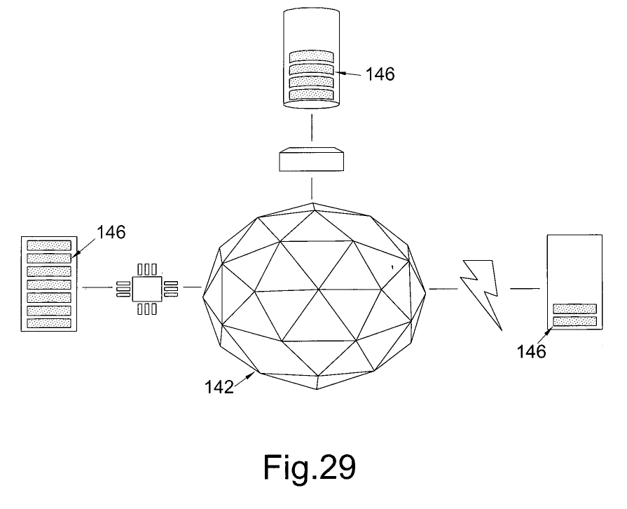

The display will incorporate a level-of-detail system, so that as a node is approached more data about the node becomes visible. By this means a network monitor can see the entire health of the network, and when a problem is flagged can zoom to a more close up view of the local network around the problem to aid diagnosis. One means of conveying more information locally is through an information ‘halo’ around a node 142. An example of such a halo is shown in FIG. 29. In this case coloured bars 146 in each of the three data zones can convey separate pieces of information. The user will have the ability to turn this halo on or off, and to choose interactively what data is shown.

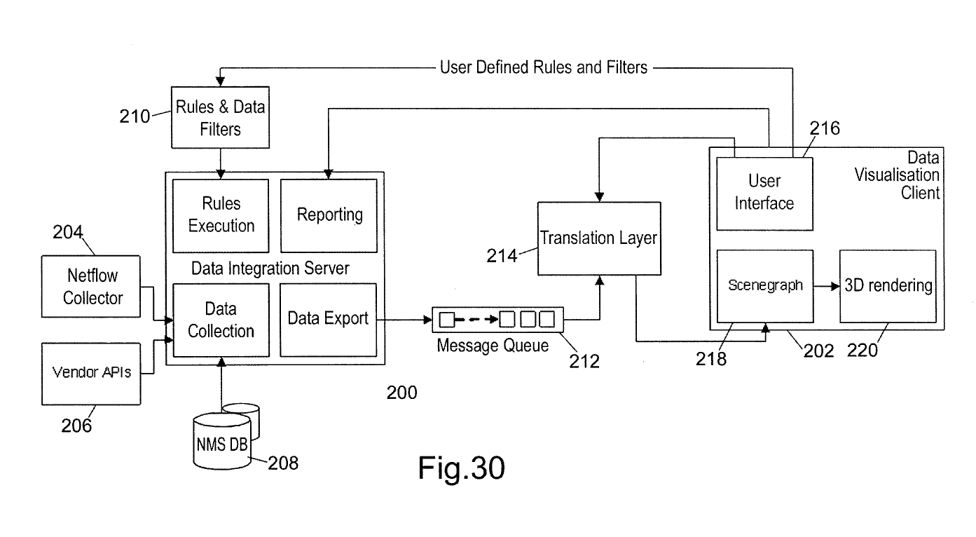

FIG. 30 illustrates an alternative arrangement of the high level design of the system architecture. The software comprises two core applications: Data Integration Server 200 and Data Visualisation client 202.

The Data Integration Server 200 allows the operator to connect to a variety of standard data sources and map data fields into ‘resource’ types that represent artefacts in the physical and logical environment that we wish to visualise, such as routers, switches, links, interfaces etc. The data sources are standard outputs from existing IT management software solutions that monitor IT infrastructure state, health, utilisation, security etc.

The Data Integration Server 200 will allow the specification of hierarchies of resources, enabling resources like a router to own sub-resources like cards and IP Interfaces. The Data Integration Server 200 vends the appropriate resource data necessary to drive the visualisation tool. The Data Integration Server 200 is a software solution that controls the specification and collection of data from disparate network data sources. It undertakes four principal functions:
Data Collection: Specification of data types, their respective sources and establishing connections to regularly schedule data updates. For example, as shown in FIG. 30, the data sources may include a netflow collector 204 which is a 3^{rd} party software to collect network traffic flow data and Vendor APIs 206 which are 3^{rd} party software to enable network data to be retrieved from vendor software databases, e.g. VMWare and Amazon EC2 Web services APIs. The data sources may also include NMS DB 208 which is an Open Source network management systems standard data sources. Other data sources may be used to capture any of the information identified above.
Rules execution: Preprocessing of data according to both pre-defined rules or user defined rules and filters.
Reporting: Presents graphical chart and tabular views of measured metric values (such as flow data, memory, CPU, temperature) over a specified time frame
Data Export: Supply data to the message queue and manage the communication with the Data Visualisation Client

Each of these four functions is illustrated as a separate module within the data integration server.

The Data Visualisation Client 202 presents a graphical user interface 216 that allows the operator to visualise all or part of the IT infrastructure with options to toggle on/off information pertaining to IT infrastructure state, network traffic, security etc. The key features of the visualisation are (i) 3D network creation, (ii) data filtering and (iii) network display (as described above). The data visualisation Client 202 also comprises a Scenegraph 218 and 3D renderer 220 which are described in more detail above and are the software that presents the data to the user on the graphical user interface 216.

The format of the presentation of the data may be defined by a user. Thus the user interface 216 is connected to the Rules and Data Filters module 210 which is a data file capturing the rules and data filters defined by the user at the User Interface. The Rules and data filters module 210 is connected to the rules execution module in the Data Integration Server 200 to allow it to fulfil the rules execution function and export data after executing the rules.

The exported data is passed between the Data Integration Server 200 and Data Visualisation Client 202 via a Message Queue 212 and a Translation Layer 214. The Message queue 212 enables the very high data volumes to pass between the Data Integration Server and the Data Visualisation Client. The Translation Layer 214 is a software and data repository that repurposes data ready for 3D visualisation. In other words, the scenegraph and 3d renderer display information on the user interface as specified in the Translation Layer. The translation layer 214 is thus connected to the user interface 216 whereby the user interface 216 may be used to specify the data to be displayed.

### Installation and Configuration

Each network is different and is firstly be defined in software before the software can be used. Each implementation should preferably follow a certain process outlined below:

1. Discovery phase
a. Gain information from customer such as IP address schema, SNMP settings, user/password combinations
b. Each device in the network should preferably firstly be discovered, this should preferably be done by ICMP ping and other methods including telnet/SSH.

2. Information gathering
a. Poll each device found using SNMP to gain static information such as Device type, vendor as well as link information, MAC address and ARP entries.
b. If SNMP not responding try to Telnet/SSH and gain required information

3. 2D map creation
a. Once all relevant information is gathered a 2D map should be created to link all discovered devices.

4. 2D map refinements and adjustments
a. Usually there needs to be refinements to a map to reflect geography, missing devices etc.

5. 3D map creation
a. Once the 2D map has been created the 3D map should be built. Using input from the 2D map this should preferably be created using defined rules.

6. 3D map refinements
a. We cannot expect the 3D map to be perfect in the initial phase after auto creation. An operator may need to refine the map to be ready for live use.

7. Active operation
a. Once the map has been created and refined the dynamic information being collected can be overlaid onto the 3D map.

8. Trending
a. After enough time has elapsed trending can be added to the functionality.

### Hardware

As shown in FIG. 20, the application may have a Client—Server architecture. The server storing all the network information and analysis; the client displaying the 3D graphics. All network data collection and analysis can be either done by specially created software, or external software can be used.

### Server

The server's main duty is as a database server and as such should preferably not require large computing power. Storage is now very cheap and a mid market 1U server with 2 terabytes of data should suffice. A version of Linux may be the operating system.

If desired the server can also run some of the audit and collection functions.

The hardware should preferably be 1->2U rack mounted servers with multiple CPUs and 4->8 Gig RAM. The sniffers/analysers may employ specialised network interface cards (NICs) or network processors to offload some/all of the deep packet inspection and/or the processing from the CPUs. It is also possible to create a RAM drive if the amount of traffic overloads the hard drive.
Sniffer/Analyser
   This product should preferably use specialised NICs, fast RAM and multiple CPUs. If we are sniffing Gigabit links and upward specialised chips/boards can be used to handle the load
Directly attached servers
   These are mainly database servers so large and fast HDs should preferably be used. They should preferably have at least 2 hot swappable hard drives so all client information can be left at site easily.
Remote servers
   These should preferably be quite high CPU/processing power; clustering or cloud computing may be used.

### Operating System

The system should preferably run on CentOS, an open source version of Redhat® enterprise.

### Security

Preferably only relevant software is installed and non essential software should preferably be shutdown and ports closed. All security patches should preferably be applied and the operation system should preferably be set to automatically update every day (if practicable). IPTables should preferably be used as a firewall and should preferably be set to Deny anything not expressly allowed.

Preferably, the only ports that are listening externally are SSH, HTTPS, Syslog, SNMP/SNMP Trap, Netflow and/or Secure FTP

### Client

As the popularity of 3D games has increased the price of very powerful GPU and CPU combinations has dramatically reduced. Currently it is possible to purchase a state of the art desktop computer with quad core CPU and a very powerful graphics setup at low cost—it is envisioned that embodiments of the software should preferably run on such a machine. A 3D games engine (eg Torque, Unity etc) is used as the base and an SQL database can be used to feed the visualisation with near real time information. For data gathering products such as OpenNMS, Netflow and the like may be employed.

No doubt many other effective alternatives should preferably occur to the skilled person. It should preferably be understood that the invention is not limited to the described embodiments and encompasses modifications apparent to those skilled in the art lying within the spirit and scope of the claims appended hereto.

We claim:

1. A 3D network optimisation tool for a network comprising a plurality of network devices and communication links between network devices, the tool comprising:
a data integration server to receive network topological data from a database defining said plurality of network devices and communication links, information flow data relating to information flow within said network and connectivity data defining connectivity of said network devices;
a data visualisation client which receives data from said data integration server, said received data being used to define a 3D representation of said network which includes 3D representations of said network devices in conjunction with a representation of said connectivity in three dimensions, said data visualisation client comprising a user interface to display said 3D representation allowing optimisation of said network based on said displayed 3D representation.

2. A 3D network optimisation tool as claimed in claim 1 further comprising a filter module connected to the data integration server whereby the data integration server processes the received data according to rules and filters defined in said filter module to determine what data is to be displayed and how said data is to be displayed.

3. A 3D network optimisation tool as claimed in claim 2 wherein said filter module is connected to said user interface whereby a user is able to define said rules and filters.

4. A 3D network optimisation tool as claimed in claim 1, further comprising a translation layer connecting said data integration server and said data visualisation client; said translation layer being operable to process data received from said data integration server to define said 3D representation of said network.

5. A 3D network optimisation tool as claimed in claim 4, wherein said translation layer is connected to said user interface whereby a user is able to specify the data to be displayed.

6. A 3D network optimisation tool as claimed in claim 1, wherein the data visualisation client comprises a 3D renderer connected to said user interface to display on said user interface said 3D representation of said network.

7. A 3D network optimisation tool as claimed in claim 1, wherein a said 3D representation of a said network device comprises a plurality of 2D panels each corresponding to a face of said 3D representation of said device and comprising information on said network device, wherein said user interface is operable to allow a user to select a said 3D representation and expand a said 3D representation to view any of said 2D panels.

8. A 3D network optimisation tool as claimed in claim 1, wherein said 3D representation of each said network device is assigned a colour to represent its temperature.

9. A 3D network optimisation tool as claimed in claim 1, wherein said data visualisation client is configured to replay an optimisation of captured data from said network in faster than real time.

10. A 3D network optimisation tool as claimed in claim 1, wherein said data visualisation client is configured to depict a communication path of an application operating over said network whereby the 3D computer network optimisation tool is usable for optimisation of network routing.

11. A 3D network optimisation tool as claimed in claim 1, wherein said user interface comprises a multi-touch user interface for manipulating said 3D representation of said network, said multi-touch user interface enabling a user of a touch screen displaying said 3D representation, by simultaneously touching said touch screen in two or more different places, to perform one or more of translation, scaling and rotation of said 3D representation of said network to optimise the performance of the network.

12. A 3D computer network visualisation tool for a computer network comprising a plurality of network devices and communication links between network devices, the tool comprising:
an input to receive
network management data from a database, said network management data including one or more of:
network device data including hardware identification data for hardware network devices of said network and/or
interface data characterising one or more interfaces of a said network device and/or
firmware identification data for a said network device and/or
operating system identification data for a said network device;
information flow data relating to information flow within said network said information data including
network device information flow load data and/or
link bandwidth data and/or
statistical information flow data;
environmental data relating to a said network device including
temperature data and/or
electrical power or energy consumption data and/or
physical network device location data;
captured network data and/or sniffer data from one or more communication links of said network; and
connectivity data defining connectivity of said network devices;
a three-dimensional (3D) visualisation module to construct a 3D representation of said network; and
an output to output data defining said 3D representation of said network, wherein said 3D representation includes 3D representations of said network devices in conjunction with a representation of said connectivity in three dimensions.

13. A 3D computer network visualisation tool as claimed in claim 12 wherein said 3D representation is constructed automatically using a set of rules operating on 3D mapping parameter data associated with one of said plurality of network devices, said 3D mapping parameter data comprising one or more of:
physical location data for said network device,
bandwidth data defining connectivity bandwidth to said network device and
network device hierarchy data, said hierarchy data defining said device to be in one of
a core region of said network
a data distribution portion of said network and
a data access or terminal portion of said network.

14. A 3D computer network visualisation tool as claimed in claim 12 wherein said network comprises at least 100 or at least 1000 said network devices.

15. A 3D computer network visualisation tool as claimed in claim 12 wherein said 3D visualisation module is configured to depict service level agreement (SLA) data, said SLA data comprising one or more of:
network device up-time guarantee data;
network device response time data; and
reliability data or packet acknowledgement response time data derived from packet transmission control protocol or TCP/IP data from said network.

16. A 3D computer network visualisation tool as claimed in claim 12 wherein said input receives RFID location data for a said network device, and wherein said 3D visualisation module is configured to depict a physical location of a said network device using said RFID location data.

17. A 3D computer network visualisation tool as claimed in claim 12 wherein said 3D visualisation module is configured to depict physical connectivity data and a physical connectivity of physical interfaces of said network devices within said network.

18. A 3D computer network visualisation tool as claimed in claim 12 wherein said 3D visualisation module is configured to depict logically partitioned sub-regions of said network, a said sub-region comprising a logical partition employed by a packet routing protocol of said network.

19. A 3D computer network visualisation tool as claimed in claim 14 wherein said 3D visualisation module is configured to depict virtual machines within said network, wherein a plurality of said virtual machines are associated with a single said network device or server in said network.

20. A method of optimising a computer network comprising a plurality of network devices and communication links between network devices, the method comprising:
receiving network management data from a database, said network management data including one or more of:
network device data including hardware identification data for hardware network devices of said network and/or
interface data characterising one or more interfaces of a said network device and/or
firmware identification data for a said network device and/or
operating system identification data for a said network device;
receiving information flow data relating to information flow within said network said information data including
network device information flow load data and/or
link bandwidth data and/or
statistical information flow data;
receiving environmental data relating to a said network device including
temperature data and/or
electrical power or energy consumption data and/or
physical network device location data;
receiving communication data from one or more communication links of said network;
receiving connectivity data defining connectivity of said network devices;
constructing, using said received data, a 3D representation of said network, wherein said 3D representation includes 3D representations of said network devices in conjunction with a representation of said connectivity in three dimensions; and
optimising said network using said 3D representation of said network.
